(19) United States
(12) Patent Application Publication
(10) Pub. No.: US 2024/0239129 A1
(43) Pub. Date: Jul. 18, 2024

(54) FUNCTIONAL ELEMENT, A METHOD FOR PRODUCING A FUNCTIONAL ELEMENT, AND A PRODUCT

(71) Applicant: OVD Kinegram AG, Zug (CH)

(72) Inventors: Corrado FRASCHINA, Zug (CH); Sebastian MADER, Zug (CH); Harald WALTER, Zug (CH); Gina OBERBOSSEL, Zug (CH)

(21) Appl. No.: 18/565,107

(22) PCT Filed: May 30, 2022
(86) PCT No.: PCT/EP2022/064514

§ 371 Date: Nov. 29, 2023

(30) Foreign Application Priority Data
May 31, 2021 (DE) 10 2021 114 002.1
Sep. 7, 2021 (DE) 10 2021 123 069.1

(51) Int. Cl. B42D 25/328; B42D 25/324; B42D 25/342; B42D 25/351; B42D 25/373; B42D 25/378; B42D 25/425; G02B 3/00; G02B 5/18

(52) U.S. Cl. CPC B42D 25/328; B42D 25/324; B42D 25/342; B42D 25/351; B42D 25/373; B42D 25/378; B42D 25/425; G02B 3/0056; G02B 5/1847

(57) ABSTRACT

A functional element 2 including at least one first relief structure 13 in at least one first area 21 and at least one metal layer 12 arranged in at least one subarea of the at least one first relief structure 13 and optionally a preferably polymeric dielectric layer on the side of the metal layer 12 which faces the observer, wherein the at least one first relief structure 13 has a periodic variation of elevations and depressions in the x- and y-direction, wherein the elevations succeed each other with a grating period Λ which is smaller than a wavelength of the light visible to the human eye, wherein the minima of the depressions define a base surface and wherein the at least one first relief structure 13 has a relief depth t. Further, a method for producing or modifying a surface and a product 1 having such a functional element 2.

The invention relates to a functional element, in particular a security element, a decorative element, a product surface, or a color standard, a method for producing a functional element, in particular a security element, a decorative element, a color standard, or in particular for modifying a product surface, and a product, in particular a security document or a decorated surface.

Product manufacturers are faced with the challenge of drawing the attention of potential target groups to their products through an appealing design of their products or the surfaces thereof using functional elements, for example comprising an optical functionality. A visually appealing appearance increases brand recognition, provides dissociation from the competition and improves the probability of forgery and imitation. A further challenge is to equip, modify and/or decorate products with a functional surface, for example with a sensor function and/or with a directly structured surface.

Known functional elements have, for example, holograms or a computer-generated diffraction grating. Such functional elements usually generate an optically variable effect by targeted diffraction of the incident light into the first and/or into one or more of the higher diffraction orders. In direct reflection, however, they usually appear only as a more or less reflective surface. Other known functional elements act as interference filters and are formed of an arrangement of several conductive and/or dielectric layers, wherein the dielectric layers have different refractive indices. Through the interference filter, this type of functional element generates color effects in direct reflection.

It is further known to provide functional elements which produce optical effects through the combination of a color print with a metallic mirror and/or known, preferably metalized, relief structures. However, a problem here is the always present and optically recognizable register tolerance between the color print and the underlying relief structure and/or the boundaries of the mirror surface. This register tolerance therefore restricts the design possibilities and/or the protection against forgery. Furthermore, if a mirror surface lies underneath the color print, such a functional element does not have a color tilt effect.

In addition to their optical design, functional elements can also satisfy a security aspect and are for example to guarantee the recognition and authenticity of a product. However, imitations and forgeries of above-named functional elements, in particular of security elements or decorative elements, represent an increasing challenge for their manufacturers and can, among other things, result in security risks or in considerable industrial financial losses. Moreover, it has been shown that the quality and the appearance of imitations and forgeries of known functional elements, for example by means of dot matrix and Kinemax origination machines, are also increasing.

There is therefore a need for novel functional elements with optical effects based on structures which can be checked and/or recognized visually without aids (1st line features), and clearly differ in appearance from the optical effects based on the production possibilities of the above-named origination machines and cannot be reproduced by the latter, and draw the attention of the target group to themselves through novel optical effects.

The object of the invention is therefore to specify an improved functional element as well as a method for producing an improved functional element or in particular for modifying a product surface, and a product comprising the improved functional element, which is characterized by novel functional structures.

The object is achieved with a functional element, in particular a security element, a decorative element, a product surface, or a color standard, preferably according to one of claims 1 to 58, comprising at least one first relief structure in at least one first area and at least one metal layer arranged in at least one subarea of the at least one first relief structure and optionally a preferably polymeric dielectric layer on the side of the metal layer which faces the observer, wherein the at least one first relief structure has a periodic variation of elevations and depressions in the x- and y-direction, wherein the elevations succeed each other with a grating period Λ which is smaller than a wavelength of the light visible to the human eye, wherein the minima of the depressions define a base surface and wherein the at least one first relief structure has a relief depth t.

The object is further achieved with a method for producing a functional element, in particular a security element, a decorative element or a color standard, or in particular for modifying a product surface using a functional element, preferably according to one of claims 59 to 64, wherein at least one first relief structure is arranged in at least one first area of the functional element and a metal layer is arranged at least in at least one subarea of the at least one first relief structure and optionally a preferably polymeric dielectric layer is arranged on the side of the metal layer which faces the observer, with the result that the at least one first relief structure has a periodic variation of elevations and depressions in the x- and y-direction, and the elevations succeed each other with a grating period Λ which is smaller than a wavelength of the light visible to the human eye, with the result that the minima of the depressions define a base surface and the at least one first relief structure has a relief depth t.

The object is further achieved by a product, in particular a security document or a decorated surface, preferably according to claim 65, wherein the product has a functional element in particular according to one of claims 1 to 58, wherein at least one first relief structure is arranged in at least one first area of the functional element and at least one metal layer is arranged in at least one subarea of the at least one first relief structure, wherein the at least one first relief structure has a periodic variation of elevations and depressions in the x- and y-direction, and the elevations succeed each other with a grating period Λ which is smaller than a wavelength of the light visible to the human eye, wherein the minima of the depressions define a base surface and the at least one first relief structure has a relief depth t, and wherein the product is in particular a banknote, an ID document, a label for product security or for decoration, an ID card, a credit card, a cash card, a hang tag of a commercial product or a certificate, in particular software certificate, a packaging, a component part for stationary and/or mobile devices, an injection-molded component part, a directly structured aluminum component part, a motor vehicle, a decorative trim, a color filter, a sensor, an optical component part or a light control.

By functional element is preferably meant an element which preferably provides a function, wherein this function can be for example security, decoration and/or optical functionality. The functional element can for example be arranged in a product, with the result that the product can benefit from the functionality of the element.

Thus, the functional element can be designed for example as a film, in particular as a laminating film or label film or a transfer film. Further, it is also possible for the functional element to be arranged on a product which is designed as a film, in particular a multilayer film, wherein the functional element forms one or more layers of the product.

The profile shape, the grating period Λ and/or the relief depth t of the at least one first relief structure is chosen in particular such that at least at a first angle of incidence and/or emergence a colored, in particular a golden or coppery, first color impression forms in direct reflection in the at least one subarea of the at least one first area in which the metal layer is arranged. Here, the light incident at least at a first angle of incidence and directly reflected by the at least one metal layer, having the relief structure, or directly transmitted through the at least one metal layer is altered, in particular altered by plasmon resonance of the at least one metal layer.

The relief depth t is determined by the spacing of the maxima of the elevation of the at least one first relief structure from the base surface in a direction perpendicular to the base surface. The grating period Λ corresponds to the spacing in the x-direction or y-direction between the maxima of two elevations or minima of two depressions, wherein these are separated only by one depression or elevation.

By area is meant here in particular in each case a defined surface of a layer or film or plane or ply which is occupied in the case of observation perpendicular to a plane formed by a layer, in particular by the at least one relief structure. Thus, for example, the functional element has the relief structure at least in a first area, but can also have further areas. The areas can further be divided into subareas and/or zones and/or zone areas. The spatial directions which span the plane of the area are called x-direction and y-direction.

Layers can be arranged on top of and/or underneath other layers, wherein by the expressions underneath and/or on top of is meant here in particular the arrangement of layers in relation to another layer in the case of observation by an observer from an observation direction. Thus, it is expedient if the terms underneath and/or on top of represent a frame of reference. The observation direction is preferably chosen such that a layer is observed perpendicular to a plane spanned by a layer.

Deviations from this are expediently indicated with an angle from the normal in degrees.

The quantized oscillations of the charge carrier density in semiconductors and metals are called plasmons, wherein they are treated quantum-mechanically as quasiparticles. Furthermore, the term plasmon is a common abbreviation of plasma oscillation quanta. The plasmon resonance in the functional elements according to the invention falls under the category plasmon polariton.

By color or chromaticity or single color or single chromaticity is meant a color location in a color space. The color space can be in particular the CIELAB color space. The color space can also be the RGB color space (R=red; G=green; B=blue) or the CMYK color space (C=cyan; M=magenta; Y=yellow; K=black) or color spaces such as RAL, HKS or the Pantone® color space.

By a different or differing chromaticity is meant a color difference dE between two color locations in a color space. The color space can be in particular the CIELAB color space. A different chromaticity that is sufficiently perceptible for the human eye has a color difference dE in the CIELAB color space of at least 2, preferably of at least 3, particularly preferably of at least 5, further preferably of at least 10.

The color location, in particular in the CIELAB color space, is usually determined with a colorimeter, for example with a “Datacolor 650” spectrophotometer.

The value of dE (or also Delta E or ΔE) between the color locations (L*,a*,b*)ₚ and (L*,a*,b*)ᵥ is calculated as a Euclidean distance:

$${dE}_{p , ν} = \sqrt{{( {L}_{p}^{*} - {L}_{v}^{*} )}^{2} + {( {a}_{p}^{*} - {a}_{v}^{*} )}^{2} + {( {b}_{p}^{*} - {b}_{v}^{*} )}^{2}}$$

Here, the lightness value L* is perpendicular to the color plane (a*,b*). The a-coordinate indicates the chroma and color intensity between green and red and the b-coordinate indicates the chroma and the color intensity between blue and yellow. The larger the positive a and b values and the smaller the negative a and b values, the more intense the color shade. If a=0 and b=0, there is an achromatic color shade on the lightness axis. Usually, L* can adopt values between 0 and 100 and a and b can vary between −128 and +127. The values for dE, L*, a* and b* are unitless.

The invention makes it possible to provide functional elements with an optical appearance which is in clear contrast to the previously known hologram effects that gleam like silver and/or are rainbow-colored. The optical appearance of the functional element according to the invention is instead characterized by a defined and largely single-color golden or coppery first color impression which is to be seen under normal observation conditions in direct reflection and/or transmission. Here, the in particular metalized relief structure is preferably embedded in a transparent polymeric layer with a refractive index preferably in the range of from approx. 1.4 to 1.6, in particular from 1.4 to 1.6, and/or is covered by such a polymeric layer.

The first color impression is stable in direct reflection over a relatively wide tilt angle range of in particular from at least 0° to 30° relative to the normal of the plane spanned by the functional element.

Only in the case of a larger angle, for example in the case of a tilt angle in the range of from 30° to 60°, does a second color impression, e.g. in magenta or in light green, become visible in direct reflection—thus βᵢₙ=αₑₓ (αᵢₙ is the angle of the incident light and αₑₓ is the angle of the reflected light). Direct reflection is also called the zero diffraction order.

Besides the color stability in the case of a tilting about an imaginary tilt axis, the first color impression is also perceived by the human eye as stable, thus as invariable, in the case of rotation of the functional element about an imaginary axis of rotation which is perpendicular to the plane spanned by the at least one metal layer. This color stability in the case of rotation of the functional element is present not only in the case of perpendicular observation—thus at αᵢₙ=αₑₓ=0°—but also in the case of tilted observation of the functional element, in particular in the tilt angle range 0° to 30° relative to the normal of the plane spanned by the functional element. In other words, the first color impression perceived by the human eye is independent or almost independent of the orientation of the grating structure.

Through this stability of the first color impression with respect to tilting over a larger angle range, it clearly differs from the so-called rainbow color effects of the first or higher order of diffraction gratings, which often already generate a plurality of rainbow colors in the case of tilting by 10°. Furthermore, the rainbow color effects of diffraction gratings do not appear in direct reflection, but only at other angles calculable with the diffraction equation.

Only in the case of tilt angle ranges of 60° or more does a third color impression, which corresponds to the first diffraction order, light up. This third color impression lighting up is not visible to an observer in the case of an observation direction for example perpendicular to the functional element, and is also called a “latent effect”.

Unlike conventional color impressions, based on absorption of light of particular wavelengths in organic dyes or color pigments, the color impression described in this document preferably forms due to absorption of light of particular wavelengths in a metal layer. A metal layer is in particular more resistant to light-induced changes than organic compounds. This results in the advantage that the fading known from organic dyes or color pigments as a result of irradiation with visible light or also light with a UV radiation portion does not occur in the case of the color impression according to the invention. The color impression is in particular lightfast. Together with the color stability over a relatively wide tilt angle range as well as in the case of rotation of the functional element, the gold- or copper-colored color impression is thus suitable in particular as a lightfast reference color in a design or also as a lightfast color standard.

Further, the invention also makes it possible to produce more cost-effective functional elements compared with known functional elements with interference filters, for example Fabry-Perot filters. Advantageously, the color effects occurring in the case of the functional element according to the invention also cannot be faked by means of usual holographic techniques and also cannot be copied by means of dot matrix and Kinemax origination machines, with the result that an additional increase in the protection against forgery is also brought about hereby.

As the colors or the color impressions of the invention form due to an in particular metalized structure itself, functional elements are made possible the gold- or copper-colored areas of which are integrated in designs, for example with silver areas of conventional functional elements such as diffraction gratings, without any register tolerance, thus in perfect register with each other.

Through such a combination, eye-catching and difficult-to-imitate functional elements with several color impressions can be generated in areas of surface neighboring each other, such as for example black, red, silver, golden and copper-colored, wherein the corresponding areas of surface, and thus their color impressions, are present in perfect register with each other. However, forgers who seek to imitate such a functional element, for example security element, in particular comprising a combination of different areas through printing one or more additional color, cannot achieve the named perfect register. Further, the optically variable color tilt effect from the first color impression to the second color impression, i.e. the change of the optical effects within the respective area of surface by altering the tilt angle, as well as the latent effect in the case of a further alteration of the tilt angle, would be absent and thus also make it possible for an untrained eye to identify a corresponding functional element, for example security element, as a forgery.

By registered or register or registration-accurately or register-accurately or registration accuracy or register accuracy is meant a positional accuracy of two or more layers relative to each other. The register accuracy is to range within a predefined tolerance which is to be as small as possible. At the same time, the register accuracy of several elements and/or layers relative to each other is an important feature in order to increase the process reliability and/or the product quality and/or the protection against forgery. The positionally accurate positioning can in particular be effected by means of sensorily, preferably optically, detectable registration marks or register marks. These registration marks or register marks can either represent specific separate elements or areas or layers or themselves be part of the elements or areas or layers to be positioned.

Further advantageous designs of the invention are described in the dependent claims.

According to a preferred embodiment example of the invention, the profile shape of the at least one first relief structure is designed asymmetrical in the x-direction and/or y-direction. In other words, the profile shape of the at least one first relief structure is designed in particular not symmetrical in the x-direction and/or y-direction. Further, it is advantageous if the profile shape varies continuously or stepwise in particular over the relief depth t. This offers the advantage that the profile shape of the at least one first preferably metalized relief structure generates a much more visible and clearer color impression for the human observer in the case of typical observation than for example symmetrical profile shapes. The exciting electrical field is advantageously localized more strongly by the asymmetrical profile shape for example at the narrow tips of the relief structure. This can lead to a more pronounced resonance and absorption. Furthermore, the excitation of the plasmons differs on the two sides of the asymmetrical profile shapes, with the result that incident light generates a different effect depending on which of the surfaces the light is radiated onto.

Symmetrical profile shapes are for example sinusoidal or rectangular or binary. In other words, symmetrical profile shapes have a mirror symmetry when the base surface is used as a mirror plane. Here, the profile shape remains the same in the case of this mirroring; the relief structure is merely shifted by half a grating period Λ. According to the invention, asymmetrical profile shapes have no mirror symmetry in the plane spanned by the base surface.

Further, it is also possible for the periodic variation of the at least one first relief structure to be superimposed at least in areas by a random and/or pseudo-random variation.

Furthermore, it is also possible to superimpose the periodic variation of the at least one first relief structure at least in areas on a microstructure, in particular on a Fresnel lens and/or a Fresnel freeform surface and/or on micromirrors and/or on blazed gratings, in particular with a grating period of more than 5 μm, and/or on computer-generated hologram (CGH) structures.

It is hereby possible to realize, in addition to the optical effects of the at least one first relief structure, such as stable color impression, color tilt effect and “latent effect”, simultaneously the optical effect of the microstructure itself or to combine the optical effects of both structures. Thus, for example, areas which, due to the microstructure, for example Fresnel freeform surfaces, an optical bulging effect virtually protruding from the surface or springing back behind the surface are not perceived achromatically, but rather as a gold-colored or copper-colored optical bulging effect of this type.

In the case of superimposition of a blazed grating structure, in particular with a grating period of more than 5 μm, i.e. with inclined macroscopic surfaces, by the first relief structure, a corresponding tilting of the first relief structure by the angle of the inclined macroscopic surface with respect to a base surface occurs, whereby this relief structure combined in this way generates a color impression with a larger observation angle range. In the case of superimposition of the first relief structure by a Fresnel lens structure or by Fresnel freeform surfaces with varying angle of the sides, a color gradient of the combined relief structure can also be realized in the case of a superimposition by the first relief structure.

It is preferred that Λ<300 nm, preferably Λ≤280 nm, preferably Λ≤260 nm, applies for the values of the grating period Λ of the at least one first relief structure in the x-direction and/or y-direction. Here, <, >, ≤ and/or ≥ corresponds to the symbols that are usual in mathematical notation. Gratings with such a small grating period Λ are also called subwavelength gratings. Further preferably, the values of the grating period Λ of the at least one first relief structure in the x-direction and/or y-direction are selected from a range of from 150 nm to 260 nm, preferably from 180 nm to 250 nm.

Further, it is advantageous that t<0.7 Λ, preferably t≤0.6 Λ, applies for the values of the relief depth t of the at least one first relief structure in the x-direction and/or y-direction. The numerical value in front of the grating period Λ is to be understood as a factor by which the grating period Λ is multiplied. If even deeper gratings are chosen, this leads to a stronger absorption, which in turn results in a comparatively darker color impression.

It is also advantageous that t>0.2 Λ, preferably t≥0.3 Λ, applies for the values of the relief depth t of the at least one first relief structure in the x-direction and/or y-direction. If the relief depth proves to be lower, this has the effect that the excitation of the plasmons is weaker, wherein the color saturation formed then proves to be only weakly pronounced, and thus only a comparatively lighter color impression, in particular a pastel-like color impression, is achieved.

Further, it is possible for the preferably asymmetrical profile shape of the at least one first relief structure to be chosen such that the width of the elevations and depressions of the at least one first relief structure relative to a distance of t/2 from the base surface is at least 60% of the grating period, preferably at least 70% of the grating period and/or at most 40% of the grating period, preferably at most 30% of the grating period. The distance of t/2 from the base surface is also called full width at half maximum. The distance between neighboring sides of the at least one first relief structure is thus determined in the case of a relief depth of t/2. Through such a design, particularly strong and defined color impressions for a potential human observer are achieved.

In particular, it is possible for the steepness of the sides of the at least one first relief structure, relative to a distance of t/2 from the base surface, to have a value in the range of from 60° to 90°, preferably of 70° and 85°.

By steepness of the sides of the at least one first relief structure is meant here the angle enclosed by the base surface and a tangent sited at a distance of t/2 from the base surface of the first relief structure at the sides of the first relief structure, i.e. sited at half the height of the first relief structure. The distance from the base surface is determined here in a direction perpendicular to the base surface.

Through the above-named values of the steepness of the sides, the advantage is achieved that the strength of the color impression generated by the at least one first preferably metalized relief structure, in particular in direct reflection or direct transmission, is further improved.

The steepness of the sides of the at least one first relief structure relative to each distance between 25% of the relief depth and 75% of the relief depth starting from the base surface is preferably chosen such that it has a value selected from a range of from 40° to 90°, preferably from 50° to 85°.

The strength of the color impression which is generated by the at least one first, in particular metalized, relief structure is hereby further improved.

Further, it is advantageous to choose a value for the steepness of the sides of the at least one first relief structure, relative to each distance between 0% and 25% of the relief depth and/or between 75% and 100% of the relief depth, starting in each case from the base surface, which has a value selected from a range of from 0° to 50°, preferably from 0° to 40°.

The strength of the color impression generated by the at least one preferably metalized relief structure can also be further improved hereby.

The at least one first relief structure is preferably formed as a 2D grating, preferably as a cross grating and/or as a hexagonal grating or as a more complex 2D grating. By more complex 2D gratings is meant for example 2D gratings with a preferably slight stochastic variation of the grating period. Further, by these is also meant 2D gratings with a periodic arrangement over a length of at least four times the locally present grating period and simultaneously with a random arrangement over lengths of more than 100 μm. 2D gratings have a sequence of elevations and depressions in the x-direction and y-direction. In the case of a cross grating or a hexagonal grating, the grating period Λ of the sequence of elevations and depressions with respect to both directions is preferably chosen in the above-specified range. Here, the grating period is in particular the same in the x-direction and y-direction. The grating period can, however, also be different in the two spatial directions.

Studies have further shown that the formation of the at least one first relief structure as a line grating, thus a 1D grating, is unsuitable. This is because in the case of these gratings only weak ones or none at all of the sought color impressions are generated. Line gratings have a periodic sequence of elevations and depressions only in one direction. Instead, line gratings are constructed from straight or also curved, in particular serpentine, lines. Through the need for 2D gratings, the protection against forgery is thus advantageously further increased, as the manufacture of cross gratings and/or hexagonal gratings requires a larger number of process steps matched to each other, and thereby represents a greater obstacle to forgers.

According to a preferred embodiment of the functional element according to the invention, the grating period Λ and/or the profile shape and/or the relief depth t of the first preferably metalized relief structure are designed such that, for an angle of incidence or observation angle of from 0° to 30°, the at least one first area has a direct reflectance of the irradiated light in at least 75% of the wavelength range of from 400 nm to 500 nm that is at least 10% lower compared with the direct reflectance in at least 75% of the wavelength range of from 525 nm to 700 nm.

It is preferred if the grating period Λ and/or the profile shape and/or relief depth t of the first preferably metalized relief structure is designed such that the at least one first area has a reflectance of the irradiated light in at least 70% of the wavelength range of from 400 nm to 500 nm that is at least 15% lower compared with the reflectance in at least 70% of the wavelength range of from 525 nm to 700 nm, further preferably that the at least one first area has a reflectance of the irradiated light in at least 90% of the wavelength range of from 400 nm to 500 nm that is at least 15% lower compared with the reflectance in at least 90% of the wavelength range of from 525 nm to 700 nm, and furthermore it is still further preferred that the at least one first area has a reflectance of the irradiated light in at least 90% of the wavelength range of from 400 nm to 500 nm that is at least 20% lower compared with the reflectance in at least 90% of the wavelength range of from 525 nm to 700 nm.

In addition to the preferred designs of the grating period Λ and/or of the profile shape and/or relief depth t of the first preferably metalized relief structure, it is preferred that the at least one first area has a direct reflectance of the irradiated light in at least 90% of the wavelength range of from 525 nm to 700 nm that is greater than 30%, preferably greater than 40%, further preferably greater than 50%, in order that the first color impression does not appear to be too dark.

The wavelength range of from 400 nm to 500 nm corresponds in particular to the wavelength range of violet and blue light and the wavelength range of from 525 nm to 700 nm corresponds in particular to the wavelength range of green, yellow, orange and red light. The above-named design of the at least one first area, in particular with respect to the grating period Λ and/or the profile shape and/or relief depth t, thus has the result that the proportion of blue and/or cyan-colored reflected light is smaller than the proportions of the remaining reflected light of the wavelength range visible to the human eye, preferably of from 400 nm to 700 nm. The first color impression thereby appears with a golden or coppery color shade in direct reflection for an observer.

The above-specified values for the direct reflectance are in particular measured values from reflection spectra in a wavelength range of from 400 nm to 700 nm. In particular, the reflection spectra in the case of perpendicular illumination and observation are preferably determined with the AvaSpec-2048 spectrometer from Avantes. The illumination is effected with the white light source LS-1 with a color temperature of 3100° K from Ocean Optics via optical fibers. In the case of reflectance measurement, a precisely defined directed light beam is directed in particular perpendicularly onto a surface and the light reflected back perpendicularly is detected by an optical fiber. This fiber guides the light to the spectrometer, which measures how much light of what wavelength is reflected. The reflectance is advantageously calibrated to 100% by standards. The dark reference here is measured against a matte-black surface and the white balance of the spectrometer is carried out against an aluminum mirror. 100% reflectance thus corresponds to the reflectance of the aluminum mirror and 0% corresponds to the reflectance of the matte-black surface. The measured reflectance is therefore preferably a value from a range of from 0% to 100%.

The at least one metal layer is preferably made of aluminum and/or silver and/or palladium and/or platinum and/or alloys thereof. In particular, the metal layer is formed of aluminum or an alloy with an aluminum proportion by weight of more than 70%, preferably of more than 90%.

The at least one metal layer is preferably vapor-deposited and/or sputtered in vacuum in the at least one first subarea of the at least one first area. Alternatively, the at least one metal layer can also be applied over the whole surface first and then removed again in the areas which are to have no metal. This can be effected using known structuring methods or demetalization methods, such as for example etching methods and/or washing methods and/or exposure methods. In particular, the at least one metal layer can be removed in areas such that the remaining metal areas are present in perfect register with areas in which structure-based effects are generated.

It is also possible to stamp the structures according to the invention into the surface of metal layers and/or of metal films and/or of metal bodies, and/or to inscribe the structures according to the invention into surfaces by means of lasers (for example by means of femtosecond lasers).

According to a preferred embodiment example of the invention, the layer thickness of the at least one metal layer is chosen such that it has an optical density (OD) selected from a range of from 0.9 to 3.0, preferably from 1.1 to 2.5, further preferably from 1.6 to 1.9. In particular for an observation of the functional element in transmission, it is advantageous if the at least one metal layer has an optical density (OD) selected from a range of from 1.6 to 1.9.

It is hereby achieved that sufficient light intensity, in particular for the observation of the functional element in transmission, passes through the area with the structure according to the invention. Simultaneously, areas which in particular have no structure according to the invention, or structures according to the invention which allow much less light to pass through a metal layer, appear sufficiently dark in order to generate a contrast easily perceptible to the human eye.

Further, it hereby becomes possible to provide a functional element with a relief structure which has an excellent color saturation in direct reflection. Further, it is thus possible to provide a functional element which exhibits a first optically variable effect in reflected light observation, and exhibits a fourth optical effect in the case of transmitted light observation. Moreover, in the case of transmitted light observation in the observation direction, the great advantage results that a corresponding optical effect becomes visible which is to be imitated or forged only with great difficulty using existing technology.

The parameter optical density (OD) here relates to the transmittance (T), thus to the permeability, of electromagnetic waves, in particular in the wavelength range of from 400 nm to 700 nm, of a metal layer relative to an unstructured, and thus smooth, metal surface. The functional relationship between transmittance (T) in percent (%) and optical density (OD) is formulated as follows: OD=Ig(100/T [%]). The optical density is thus unitless.

According to the above equation, high transmittance values yield low values of optical density, and vice versa. The theoretically greatest possible transmittance value of 100% relative to the metal layer thus leads to an optical density of 0. This corresponds to a non-existent metal layer with the thickness of zero. For example, the transmittance falls with the increase of the layer thickness of the metal layer, and the optical density increases.

The reason for the increased transmittance in the at least one first area of the at least one first relief structure is probably an increased plasmon excitation by the incident light, which is made possible by the relief structure. It is thus possible to provide a functional element according to the invention which exhibits at least one optically variable effect each in reflected light observation and in the case of transmitted light observation. It is further possible for the optical effect in reflected light observation to be different from the optical effect in transmitted light observation in the case of corresponding design. Further, it is possible in the case of corresponding design for the detected optical effect in reflected light observation observed from one side of the functional element to be different from the optical effect observed from another side. In other words, in each case an optical, preferably different, effect can be detected by an observer in the case of observation from the front or back in reflection, respectively.

The great advantage thus results that in the case of direct transmission observed at a perpendicular angle onto the plane spanned by a layer a corresponding optical effect can be visible and thus a functional element is provided which can be faked only with great difficulty using existing technology. Further, comparable effects are not possible when transmissive diffraction structures of the first or higher order are used.

The functional element according to the invention is preferably formed as a transfer film or as a laminating film or as a security thread and already has a large number of design possibilities. Furthermore, the functional element, in particular the at least one first area, can preferably have another one or more further layers selected from the group: replication layer, dielectric layer, layer made of a dye, layer made of a luminescent substance, glazing color layer, mask layer, polymer layer, metal layer, protective varnish layer, adhesive layer, detachment layer, primer layer, barrier layer, porous layer, contrast layer, sealing layer, adhesion-promoter layer, carrier layer, decorative layer.

The above-named layers can in each case be arranged individually or also in any desired combination with each other in the functional element, in particular in the at least one area, on top of and/or underneath the at least one first relief structure. The layers can be applied over the whole surface or also only partially, i.e. in areas. For example, one or more of the layers can be arranged patterned. Several patterned layers can also be arranged in register with each other. Here, the variety of design of the functional element advantageously increases still further.

The functional element is preferably designed such that one or more layers of the functional element possibly arranged on top of and/or underneath the at least one metal layer and/or one or more layers of the functional element possibly provided underneath the at least one metal layer are formed transparent or semitransparent, in particular have a transmittance, in particular in the wavelength range of from 400 nm to 700 nm, of at least 10%, preferably of at least 25%, further preferably of at least 75%, still further preferably of at least 90%, in at least in one subarea of the at least one first area.

It is hereby ensured that the optical effect generated by the at least one metal layer and the at least one first relief structure is visible in reflected light observation from the upper side, in reflected light observation from the underside and/or in transmitted light observation. The color impression of the optical effect can be the same in the case of observation from the upper side and from the underside in each case in reflected light observation. The color impression of the optical effect can also be different, for example because of the profile shape of the first relief structure and/or because of different refractive indices of the respective material on top of or underneath the at least one metal layer. A different color impression of for example gold colors observed from the upper side and reddish observed from the underside can be used for different types of functional elements, such as e.g. for a foil blanket without using dyes or for radiation and/or heat management e.g. in the case of satellites or the like.

The functional element according to the invention has for example a carrier film, preferably a transparent plastic film preferably made of PET, PC, PE, BOPP with a thickness of between 10 μm and 500 μm, a transparent replication layer, preferably made of a thermoplastic or UV-curable replication varnish, an adhesive layer, preferably a cold adhesive layer, a hot adhesive layer or a UV-curable adhesive layer and a polymer layer, preferably made of known varnish systems with a refractive index in the range of from 1.45 to 1.55. Further, the functional element according to the invention preferably has no additional thin layers made of high-refractive-index materials which are arranged in particular on top of and/or underneath the at least one metal layer. Layers made of high-refractive-index materials can be formed for example of ZnS or TiO₂. However, it can also be a high-refractive-index replication varnish layer, for example a polymeric varnish layer, which is filled in particular with high-refractive-index nanoparticles. On the one hand, this leads to a simplified production method as the method step of arranging, for example vapor-depositing, the high-refractive-index materials is omitted. These special and high-cost materials can also be dispensed with. Thus, a functional element according to the invention can therefore be integrated in known product structures particularly cost-effectively, and can thus be manufactured cost-effectively.

In a specific embodiment, the functional element, in particular seen from the side facing an observer, can have an at least partially present thin high-refractive-index layer, for example made of ZnS, on the metal layer. This at least partial high-refractive-index layer alters the color impression depending on the layer thickness, for example from gold- or copper-colored to red, since the plasmon resonance is altered. The high-refractive-index layer can be present in the form of motifs such as letters, numbers, symbol, pattern, a geometric figure, etc., whereby these motifs appear differently colored compared with the gold- or copper-colored areas without the high-refractive-index layer. The thickness of the high-refractive-index layer is preferably selected from a range of from 5 nm to 150 nm, further preferably from nm to 50 nm.

Further, it is advantageous if a dielectric layer, for example made of low-refractive-index material such as MgF₂ or of a low-refractive-index polymer layer, is arranged on top of and/or underneath the at least one metal layer. The dielectric layer is preferably printed or vapor-deposited such that it is arranged over the whole surface or in areas on the surface of the at least one metal layer. A dielectric and in particular low-refractive-index layer has in particular a refractive index of at most 1.45. The thickness of the dielectric and in particular low-refractive-index layer is preferably selected from the range of from 5 nm to 2000 nm and further preferably from 10 nm to 500 nm.

If the preferably metalized relief structure is superimposed by a color filter in a known manner, for example by applying a separate color filter which has a distance of more than 1 μm, a color mixing from the superimposition of the optical effect, in particular the color impression of the preferably metalized relief structure and the color filter function, is to be recognized for an observer. The optical effect of the preferably metalized relief structure is thus in practice dyed by the color filter in the color shade of the color filter.

According to a preferred embodiment example of the invention, the functional element has at least one dye and/or one luminescent substance, which is in particular arranged in a layer, in the first areas or in the at least one first area. The dye and/or luminescent substance is preferably arranged less than 1 μm, further preferably less than 750 nm, still further preferably less than 500 nm, furthermore still further less than 300 nm, away from one of the surfaces of the at least one metal layer. The dye and/or luminescent substance is preferably arranged in the dielectric layer or a polymer layer.

The dye and/or the luminescent substance can be applied for example by means of printing process or in vacuum, e.g. by means of thermal vapor deposition.

Such a close arrangement of the dye and/or of the luminescent substance on the surface of the at least one metal layer with the first relief structure advantageously brings about a greatly increased absorption and/or fluorescence. The enhancement mechanism is called plasmon-enhanced absorption and plasmon-coupled emission. This distinguishes the first relief structure substantially in particular from mirror surfaces or “normal” diffractive structures, in which this enhancement effect does not occur.

The dye and/or the luminescent substance can be applied or have been arranged over the whole surface or in areas, for example in the form of motifs recognizable to the human eye such as letters, numbers, symbols, patterns, a geometric figure, etc. The dye and/or the luminescent substance is preferably arranged only in areas on the at least one metal layer. Further, the dye and/or the luminescent substance is provided only where the at least one metal layer adjoins the at least one first relief structure and generates the above-described effect.

The term luminescent substance denotes in particular a fluorescent or phosphorescent substance. Typical fluorescent substances are excited by UV radiations in the region of 395 nm and/or 365 nm and/or 313 nm and/or 254 nm. Fluorescent substances are known in which an excitation emit only in one wavelength range or also in several wavelength ranges accompanied by emission of identical or similar or different colors depending on the irradiated wavelength in the visible range.

The dye and/or the luminescent substance can be applied using a printing method or in vacuum.

Examples of vacuum-applied dyes are Patinal Black A or Brown A from Merck as well as metals absorbing light in the visible spectral range, preferably in the wavelength range of from 400 nm to 700 nm, such as gold, copper or chromium. If such metals are used as dye layer, a very thin dielectric layer, for example the natural oxide layer, a few nanometers thin, of a vapor-deposited aluminum layer, preferably lies between the metal layer and the dye layer. For example, the thickness of this dielectric layer is between 2 nm and 10 nm. This ensures that in particular the absorption properties of the dye layer made of a strongly absorbing metal is not unfavorably altered by the electrical connection to the metal layer.

When printing methods are used other dyes and/or luminescent substances than those in the case of vacuum-application are preferably used. The dye and/or the luminescent substance is preferably a soluble dye or luminescent substance or insoluble nanoparticles or pigments. Dyes from the following substance groups are preferably used as dye: metal complex dyes, in particular with Cr³⁺ or Co²⁺ as central atom. Luminescent substances selected individually or in combination from the following substance groups are preferably used: coumarins, rhodamines, cyanines.

The dye and/or the luminescent substance can have a variable absorption behavior reacting to external influences. This variable absorption behavior can be reversible or also irreversible and preferably brings about a color change.

A functional element according to the invention can have a sensor layer. By sensor layer is meant in particular a preferably polymeric layer which contains the dye and/or the luminescent substance which has an absorption behavior reacting variably to external influences.

Examples of variable dyes and/or luminescent substances reacting to external influences are chromogenic materials, which alter their color or their transparency depending on temperature (thermochromic materials), light incidence (photochromic materials), electrical voltage and/or current as well as under pressure.

In particular a predetermined temperature change triggers the color change in the case of thermochromic dyes and/or luminescent substances, and in particular a predetermined radiation intensity triggers it in the case of photochromic dyes.

A functional element according to the invention can be designed as a sensor element, in particular comprising a preferably polymeric sensor layer. In particular, a functional element according to the invention which preferably contains a thermochromic dye and/or luminescent substance can be used for example in the foodstuffs industry in a time-temperature indicator (also called TTI). Such a sensor can for example indicate a break in the cold chain. Thermochromic dyes are normally substances which have a structural phase transition which is attended by a color change. An example of a thermochromic dye consists of a mixture of anthocyanidin dye cyanidin chloride, dodecyl gallate and hexadecanoic acid, as described in J. Mater. Chem. C, 2013, 1, 2811-2816.

An example of a photochromic dye is bacteriorhodopsin. A functional element which contains a photochromic dye, in particular bacteriorhodopsin, can be used as a security element which changes color when irradiated with a sufficiently high intensity. Alternatively, a functional element can thus be a light-intensity sensor element in a light-intensity sensor.

A further example of variable dyes and/or luminescent substances reacting to external influences are, are pH-sensitive dyes and/or luminescent substances, which show different colors in aqueous solution depending on the pH.

For example, methyl orange, bromothymol blue or phenolphthalein are suitable. They show different colors in aqueous solution depending on the pH. Phenolphthalein for example is transparent for pH values smaller than 8 and becomes magenta-colored from pH values of 9. In the case of a very high pH value close to 14 it becomes colorless again. In the case of a quite low pH value smaller than zero the indicator changes color to red orange.

A sensor layer comprising a dye and/or a luminescent substance which is pH-sensitive can be used for example as a pH sensor.

A further example of variable dyes and/or luminescent substances reacting to external influences are substances which react with substances, for example gaseous or liquid substances, wherein the reaction product has a different complex refractive index, absorption coefficient and/or color impression from the dye and/or the luminescent substance. For example, perylene reacts with gaseous NO₂, with the result that it is detectable through a color change in the case of sufficient concentration.

The pigmentation level and/or the proportion by volume of the dye and/or of the luminescent substance can be up to 100% in the layer containing the dye and/or the luminescent substance, in particular if the dye is vacuum-applied. The pigmentation level and/or the proportion by volume of the dye and/or of the luminescent substance is preferably more than 50%, further preferably more than 75%, and still further preferably more than 90%. In the case of such high pigmentation levels and/or proportions by volume of the dye and/or of the luminescent substance, the dye layer can be designed extremely thin, whereby the dye and/or the luminescent substance is present maximally close to the metal layer.

The pigmentation level and/or the proportion by volume of the dye and/or of the luminescent substance of the layer, in particular applied in the printing method, containing the dye and/or luminescent substance is preferably less than 15%, preferably less than 10%, further preferably less than 5%, in particular if dyes and/or luminescent substances are used which, without a stabilizing matrix, e.g. made of polymer, would not have a sufficient adhesion to the metal layer and/or would bring about a chemical reaction with the metal layer.

Mixtures of different pigments or dyes or luminescent substances can also be used.

The layer containing the dye and/or the luminescent substance is preferably transparent and/or has a transmittance, in particular in the wavelength range of from 400 nm to 700 nm, of at least 10%, preferably of at least 25%, further preferably of at least 75%, still further preferably of at least 90%. It is herewith guaranteed in particular that, if the dye is also applied in subareas in which no relief structure according to the invention and/or no metal layer is arranged, no substantial dyeing of an underlying layer is recognizable.

Through the arrangement of a dye and/or of the luminescent substance, the generated first color impression can be altered in a targeted manner in particular in direct reflection. For example, it is possible for the dye and/or the luminescent substance to have an absorption maximum in the case of a wavelength of 550 nm, wherein the absorption has a Gaussian distribution with a width selected from a range of from 25 nm to 100 nm, preferably from 40 nm to 60 nm. As this would lead to a deep slump in the reflectance at 550 nm, arranging such a dye and/or luminescent substance results in a reddish first color impression. For example, gold nanoparticles with a diameter of approx. 20 nm have an absorption maximum at approx. 520 nm.

The dye and/or the luminescent substance can be provided over the whole surface or also only partially in individual areas of surface. Through a partial application in areas of surface it is achieved that the first color impression is to be observed only in the areas of surface with dye and/or with luminescent substance, and the first color impression is not present neighboring these, where no dye and/or no luminescent substance is applied. Designs which generate a contrast of the first color impression with other optical effects can thereby be generated. When for example photochromic dyes and/or luminescent substances are used, besides subareas which have the color change in the case of irradiation for example, color-stable subareas with the first color impression as reference color can thus also be realized. In the subarea which contains a chromogenic dye and/or luminescent substance, the first color impression before the color change is preferably substantially the same as or different from the color impression of a subarea which contains no chromogenic dye.

Further, after the color change, the first color impression of the subarea which contains a chromogenic dye and/or luminescent substance is preferably different from the color impression of the subarea which contains no dye and/or luminescent substance.

Further, it is possible for at least one glazing color layer to be arranged over the whole surface or partially at least in areas or over the whole surface on the at least one first area and/or further areas. This glazing color layer can directly adjoin the metal layer or be spaced apart from the metal layer by a dielectric intermediate layer.

The at least one glazing color layer here acts as a color filter and generates a detectable color impression in the corresponding coloring of the color filter for an observer. In addition to the color filter effect, at a correspondingly small distance from the metal layer of preferably less than 1 μm, further preferably less than 750 nm, still further preferably less than 500 nm, furthermore still further less than 300 nm, the glazing color layer can also, as described above, alter the first color impression through greatly increased absorption and/or fluorescence by means of plasmon-enhanced absorption as well as plasmon-coupled emission.

The color impression, detectable for an observer, of the first relief structure and/or of the further relief structures and/or of the mirror surfaces underneath the glazing color layer can be determined as a combination of the optical effects of the corresponding relief structures and/or mirror surfaces with the dyeing by the glazing color layer. In particular, the at least one glazing color layer is transparent and/or has a transmittance, in particular in the wavelength range of from 400 nm to 700 nm, of at least 10%, preferably of at least 25%, further preferably of at least 75%, still further preferably of at least 90%.

Two or more glazing color layers can be present next to each other. Alternatively, two or more glazing color layers can also be present overlapping at least in areas. In the overlapping areas of the two or more glazing color layers a mixed color forms from the colors of the two or more color layers and in particular the underlying at least one first area.

The thickness of the at least one glazing color layer is preferably less than 10 μm, preferably less than 5 μm, further preferably less than 2 μm. In particular, the pigmentation level and/or the proportion by volume of the dye and/or luminescent substance of the glazing color layer is less than 15%, preferably less than 10%, further preferably less than 5%. The dyes of the glazing color layer are preferably soluble dyes.

In an embodiment the at least one glazing color layer can be arranged at a distance from one of the surfaces of the at least one metal layer of less than 500 nm, preferably less than 200 nm, still further preferably in direct contact with one of the surfaces at least one metal layer.

Further, it is also possible for the at least one first area to have a subarea which is formed patterned and in particular to have a subarea surrounding this subarea.

Further, at least one layer, in particular a mask layer, which is formed opaque, can be arranged in the surrounding subarea, with the result that the optical effect generated by the at least one metal layer and the at least one first relief structure is visible only in the subarea of the at least one first area which is not covered by the opaque layer. Interesting optical effects can hereby be achieved through the shaping of the subareas.

The profile shape and/or the relief depth and/or grating period of the at least first relief structure is preferably further chosen such that in the case of a second angle of incidence different from the first angle of incidence the colored appearance of the light directly reflected in the at least one first area or directly transmitted through the at least one metal layer is altered differently.

In particular, a first color impression appears in direct reflection in the case of a first angle of incidence and a second color impression appears in direct reflection in the case of a second angle of incidence, wherein, in particular starting from the normal perpendicular to the base plane of the relief structure, the first angle of incidence is selected from a range of from 0° to 30° and in particular wherein the second angle of incidence is larger than the first angle of incidence by a value selected from a range of from 10° to 45°. For example, the second angle of incidence is a value selected from a range of from 30° to 60°. A defined color change when tilted or a color tilt effect is herewith made possible. At the first or the second angle of incidence in the case of reflected light observation and/or in the case of transmitted light observation, in particular different, stable color impressions thus appear in direct reflection for the human observer.

In particular, the second color impression is dependent on the azimuthal angle. Thus, a functional element can be designed such that it has a first area which has an azimuthal angle of further first area different or rotated by at least 15°, preferably by 30° and further preferably by 45°. For example, in the case of an azimuthal angle of 0° or 90° a second color impression can be generated which is different from the second color impression in the case of an azimuthal angle of for example 45°. As the color tilt effect is structure-based, it is in perfect register with other structure-based effects. In particular, another advantage of this effect is that the same first color print forms independently of the chosen azimuthal angle in both first areas in the case of the same profile shape, relief depth or grating period. In the case of a first observation angle of for example 10°, all first areas here have the same color impression, for example gold-colored. In the case of a second observation angle of for example 40°, on the other hand, the color impressions in the areas differ depending on the grating orientation, i.e. depending on the azimuthal angle in the respective area, and a concealed item of information only becomes visible at this second observation angle. Such a color effect is also called a metameric color effect.

By azimuthal angle is meant in particular the orientation of a relief structure in the plane spanned by the base surface, wherein the x-direction corresponds to 0° and the y-direction corresponds to 90°. The orientation of a relief structure can be rotated by a defined angle in relation to a further relief structure, to the base surface of which the x-direction and the y-direction is linked.

In the case of a third angle of incidence different from the first and second angle of incidence, an optical appearance which is different from the optical appearances of the first and second angle of incidence preferably appears due to the light diffracted into the first diffraction order in the at least one first area. This optical appearance is called a latent effect and corresponds to the lighting-up of the first diffraction order.

According to a preferred embodiment example of the invention the functional element has at least one second area, wherein at least one second relief structure and/or a mirror surface without relief structure molded into this mirror surface is formed in the at least one second area. The at least one second relief structure is a relief structure which is preferably selected individually or in combination and/or superimposed from: diffractive relief structure, holographic relief structure, in particular 2D, 2D/3D or 3D hologram, matte structure, micromirror surface, reflective facet structure, refractive, almost achromatic microstructure, preferably blazed grating with a grating period of more than 5 μm, lens, microlens grid, binary random structure, binary Fresnel-shaped microstructure. In particular, a metal layer, which can preferably be designed analogously to at least one of the preferred embodiments of the metal layer in the at least one subarea of the first area, is arranged in a subarea of the at least one second area.

The at least one second relief structure is thus designed such that the at least one second area, in particular under diffuse illumination, preferably appears silver and/or in the intrinsic color of the metal which is arranged in the at least one second area and/or into which the at least one second relief structure is stamped.

By diffractive relief structure is meant in particular a relief structure which has a spatial frequency selected from a range of from 200 lines/mm to 2000 lines/mm and in particular generates an optically variable effect due to diffraction of the incident light into the first or a higher diffraction order. These optically variable effects can be for example rainbow-like color effects and/or movement effects and/or pumping effects and/or transformation effects. Examples of diffractive relief structures comprise for example line gratings or cross gratings. Further, diffractive relief structures can also be formed by computer-generated holograms, for example by kinoforms.

Isotropically scattering or anisotropically scattering matte structures can be used as matte structures. Matte structure denotes a structure with light-scattering properties which preferably has a stochastic or random surface profile. Matte structures preferably have a relief depth t in the range of from 100 nm to 5000 nm, preferably from 200 nm to 2000 nm. Furthermore, matte structures preferably have a roughness average Ra selected from a range of from 50 nm to 2000 nm, preferably from 100 nm to 1000 nm. The matte effect can be either isotropic or anisotropic.

By microstructure is meant a structure the spatial frequency of which is smaller than 200 lines/mm, or the grating period of which is greater than 5 μm and which generates an optical effect substantially by refraction. The effect is thus almost achromatic.

Lenses can be molded as refractively acting lenses or as refractively acting concave mirrors or also as diffractive lenses or diffractive concave mirrors. A microlens grid is preferably formed by a one-dimensional or two-dimensional arrangement of microlenses, for example of cylindrical lenses in a one-dimensional arrangement of the microlenses or of microlenses with an in each case spherical or approximately spherical or aspherical shape in a two-dimensional arrangement of the microlenses. The grid width of a microlens grid preferably has a value selected from a range of from 5 μm to 300 μm, further preferably from a range of from 5 μm to 50 μm.

According to a preferred embodiment example of the invention the functional element has at least one third area, wherein at least one third relief structure is formed in the at least one third area. The at least one third relief structure is in particular a relief structure which comprises gratings with a grating period Λ of less than 500 nm and more than 300 nm and a relief depth t of more than 150 nm. The at least one third area is designed such that in direct reflection over a relatively wide tilt angle range of from in particular at least 0° to 30° relative to the normal of the plane spanned by the functional element it preferably has a red or a dark color impression, in particular a black color impression, in direct reflection or in transmission. In particular, a metal layer, which can preferably be designed analogously to at least one of the preferred embodiments of the metal layer in the at least one subarea of the first area, is arranged in a subarea of the at least one third area.

As the optical effects such as the color impression of the different areas are substantially generated by structures, in particular the at least one first area, the at least second area and the at least one third area can be arranged register-accurately relative to each other, as the arrangement of additional varnish layers for a colored design can be dispensed with.

This further enables in particular the colored design of self-explanatory design elements arranged in perfect register, such as for example flags. The self-explanatory design elements can expediently be supplemented or expanded by further structure-based effects.

The color stability in the case of a tilting of the functional element in combination with the perfect register of the color impression in direct reflection of the corresponding different areas relative to each other can be used for the detection and/or recognition and/or verification of the functional element in machine, in particular automated, processes such as “optical machine authentication” and “optical phone authentication”. The reading devices used for this can be stationary or also mobile.

Stationary reading devices, such as are used for example for passport control at airports or also at border crossings, often have the possibility of capturing the passport page with the security elements in the case of diffuse illumination. Here, the subareas having the color impression according to this invention appear very high-contrast in the image acquisition, whereby the register accuracy of the color impression relative to subareas appearing silver can be verified by means of a suitable image evaluation. In the case of mobile reading devices, such as for example smartphones with suitable software, image acquisitions can also be generated which can be used for the verification of the register accuracy of different image elements relative to each other. The software preferably instructs the user to optimize the illumination such that the verification is optimally possible.

According to an embodiment example of the invention, the at least one first area, the at least one second area, the at least one third area or at least one of the first, second or third areas has a patterned shaping. One area can be molded for example in the shape of letters, numbers, a symbol, a geometric figure or a motif. In particular, the at least one first area can be designed as minitext or microtext.

By text is preferably meant a sequence of two or more letters, symbols or numbers, wherein a minitext preferably has a character height in the range of from 0.5 mm to 2.5 mm and a microtext preferably has a character height in the range of from 0.125 mm to 0.5 mm. By nanotext is meant texts with character heights smaller than 0.125 mm.

Further, it is possible for the first and/or second and/or third areas to be arranged as a plurality of pixels. The pixels can be designed round, square, hexagonal, motif-shaped or also in another coherent shape. The pixels can further also have an elongated shape, in particular a line shape. The maximum extent of a pixel in at least one direction of the spatial directions, preferably in the x-direction and y-direction, is preferably smaller than 300 μm, preferably smaller than 100 μm, further preferably smaller than 10 μm, still further preferably smaller than 5 μm, furthermore still further preferably smaller than 3 μm. Further, it is advantageous if a pixel is formed larger than 1 μm, preferably larger than 1.5 μm, in the x-direction and/or y-direction. The above extents of the pixels provide the effect of high resolutions of the information represented. Stronger optical effects, for example movement effects over larger distances, can thus be realized. Further, the extents of the pixels are large enough that the at least one relief structure of the at least one first area hereby still has a sufficient number of grating periods, with the result that it can still generate its optical effect.

Further, it is possible for at least one glazing color layer to be arranged, in particular over the whole surface or partially, at least in areas or over the whole surface in the viewing direction of an observer, in particular perpendicular to the plane spanned by the functional element, behind and/or underneath the at least one first area and/or second area and/or third area and/or further areas.

In other words, it is possible for at least one glazing color layer to be arranged in the viewing direction of an observer, in particular perpendicular to the plane spanned by the functional element, at least in areas or over the whole surface underneath the at least one first relief structure, the at least one second relief structure, the at least one third relief structure and/or at least one mirror surface and/or the metal layer. It is possible for the at least one glazing color layer to be arranged in the viewing direction of an observer, in particular perpendicular to the plane spanned by the functional element, such that it completely or partially overlaps with the at least one first, second and/or third area. It is also possible for at least one glazing color layer not to overlap with the at least one first, second and/or third area.

The at least one glazing color layer can directly adjoin the metal layer or be spaced apart from the metal layer by a dielectric intermediate layer. The at least one glazing color layer here preferably acts as a colored background and thus as an optically contrasting area and in particular generates for an observer a detectable color impression in the corresponding coloring of the at least one color layer.

It is advantageous if the at least one glazing color layer, in particular in direct reflection over a tilt angle range of from preferably at least 0° to 30° relative to the normal and/or over a tilt angle range of from preferably at least 30° to 60° relative to the normal, in particular in the CIELAB color space, have a total ink holdout dE of from 50 to 270, preferably from 100 to 270, further preferably from 130 to 270, from the first and/or from the second and/or from the third area, in particular from the at least one subarea of the at least one first, second and/or third area in which a metal layer is arranged.

It is also advantageous if the at least one glazing color layer, in particular in direct reflection over a tilt angle range of from preferably at least 0° to 30° relative to the normal and/or over a tilt angle range of from preferably at least 30° to 60° relative to the normal, has a darker color, in particular with a lower lightness value L, in particular compared with the at least one first and/or second and/or third area, and the at least one first and/or second and/or third area has a lighter color, in particular with a higher lightness value L, in particular compared with the at least glazing color layer.

Furthermore, it is advantageous that the at least one glazing color layer, in particular in direct reflection over a tilt angle range of from preferably at least 0° to 30° relative to the normal and/or over a tilt angle range of from preferably at least 30° to 60° relative to the normal, has a lighter color, in particular with a higher lightness value L, in particular compared with the at least one first and/or second and/or third area, and the at least one first and/or second and/or third area has a darker color, in particular with a lower lightness value L, in particular compared with the at least one glazing color layer.

A first color is preferably understood as lighter compared with a second color if the first color has a higher lightness value L compared with the second color. Analogously, a third color is preferably understood as darker compared with a fourth color if the third color has a lower lightness value L compared with the fourth color.

It is advantageous if the first area and/or the second area, in particular in direct reflection over a tilt angle range of from preferably at least 0° to 30° relative to the normal and/or over a tilt angle range of from preferably at least 30° to 60° relative to the normal, in particular in the CIELAB color space, have a total ink holdout dE of from 50 to 270, preferably from 100 to 270, further preferably from 130 to 270, from the third area, and/or if the first area and/or the second area, in particular in direct reflection over a tilt angle range of from preferably at least 0° to 30° relative to the normal and/or over a tilt angle range of from preferably at least 30° to 60° relative to the normal, has a lighter color, in particular with a higher lightness value L, preferably compared with the third area, and the third area, in particular in direct reflection over a tilt angle range of from preferably at least 0° to 30° relative to the normal and/or over a tilt angle range of from preferably at least 30° to 60° relative to the normal, has a darker color, in particular with a lower lightness value L, preferably compared with the first and/or second area.

Alternatively, the first and/or second and/or third areas can also be arranged in a grid arrangement. It is also possible for the first and/or second and/or third areas to be arranged interlaced. That means that in each case first and/or second and/or third areas are arranged succeeding each other in an alternating manner and in particular directly neighboring each other. The first and/or second and/or third areas have a small distance and/or size at least in one dimension of less than 300 μm, preferably of less than 100 μm.

Further, it is possible for the at least one first area to be designed such that it is arranged at least in two, preferably at least three, preferably at least five zones. The zones are preferably designed such that they are arranged at least partially more than 300 μm, preferably at least 1000 μm, away from each other in the x-direction and/or y-direction, with the result that they are perceived by the human eye as separated from each other. In particular, one, preferably each, of the zones has at least one first zone area which is formed smaller than 2 mm, preferably smaller than 1 mm, further preferably smaller than 0.7 mm, in at least one spatial direction. Here, it can be advantageous that the at least one first zone area makes up at least 20%, preferably at least 30%, further preferably more than 50%, of the surface area of an individual zone.

This has the advantageous effect that it is hereby made more difficult for forgers to imitate for example the golden color impression by means of partial overprinting with yellow ink of a forged element which does not have the light-absorbing grating structures. Thus, the perfect register cannot be sufficiently achieved via a registered color printing, for example by means of inkjet printing.

It is also possible for at least one zone to have at least one second zone area which is larger than 2 mm, preferably larger than 3 mm, further preferably larger than 5 mm, in at least one spatial direction, in particular wherein the surface area of the second zone areas of all zones is at least in total larger than 20 mm², preferably larger than 30 mm², further preferably larger than 50 mm². This minimum surface area of the more extensive zone areas makes it easier for an observer to perceive the golden or coppery color impression reliably.

Further, it is also possible for the extent of at least one zone in one spatial direction to be reduced, preferably to taper continuously or stepwise. The eye of an observer is thereby guided by the more easily detectable, wider second zone areas also to look at the narrower first zone areas. In these areas, the perfect register of the at least one first zone area relative to the further areas, subareas or zones of the functional element is more difficult for forgers to imitate.

Further, the at least one first area can be framed only in areas or even completely enclosed by the at least one third area, wherein the at least one third area has an extent in one of the spatial directions selected from a range of from 30 μm to 1 mm, preferably from 50 μm to 300 μm, further preferably from 50 μm to 150 μm. The at least one third area thus forms a contour-like frame or partial frame, which frames or surrounds the at least one first area in areas or completely. The contour of the at least one first area is hereby still further emphasized and the recognizability is improved for an observer by an increase in contrast. The optical effects in the first and second and third area preferably have as different as possible a chromaticity and thus as good as possible an optical contrast relative to each other. For example, a second area can have a Fresnel freeform surface, wherein this second area is enclosed with a first area with the first relief structure with the golden color impression.

In a further embodiment, the at least one first area can be framed in areas or even completely enclosed by at least one second area, wherein the at least one second area has an extent in one of the spatial directions selected from a range of from 30 μm to 1 mm, preferably from 50 μm to 300 μm, further preferably from 50 μm to 150 μm. In particular, the at least one second area can here be framed in areas or even completely enclosed by at least one third area, wherein the at least one third area can be designed as in the preceding paragraph. Further, the at least one second area can have a microtext or nanotext.

Through such a design it is brought about that by the optical effect of the at least one second area the observer's attention is drawn to the area around the contour and thus to the perfect register between the areas or contours appearing different in direct reflection.

According to an embodiment of the invention, a plurality of microlenses can be arranged in the form of a grid on top of the at least one first area. In particular, by “arranged in the form of a grid” is meant an arrangement in a grid. In particular, the microlenses are arranged such that the at least one first area is perceived enlarged by an observer. In other words, the at least one first area lies in the focal plane of the microlenses. The microlenses can in each case have a cylindrical or lenticular or a spherical or approximately spherical shape or aspherical shape or other shapes.

A microlens grid can have several microlens partial grids, wherein preferably within a microlens partial grid the microlenses are arranged as cylindrical lenses in a one-dimensional arrangement of the microlenses or microlenses with an in each case spherical or approximately spherical or aspherical shape are arranged in a two-dimensional arrangement of the microlenses. In particular, several microlens partial grids different from each other can be arranged within a microlens grid. For example, at least one microlens partial grid with a two-dimensional arrangement of the microlenses and at least one microlens partial grid with a one-dimensional arrangement of the microlenses can be provided within a microlens grid. The microlens partial grids can have a different outer shape, in particular triangular, polygonal, round, elliptical, motif-shaped, patterned, in the form of a coding. Here, these microlens partial grids with one-dimensional or two-dimensional arrangements of microlenses preferably have in each case the same grid width and/or in each case the same focal length.

In particular, the at least one first area is here arranged in subareas such that the subareas reveal a plurality of microimages or Moiré icons arranged in the form of a grid, in particular wherein these microimages or Moiré icons are arranged in register with the plurality of microlenses arranged in the form of a grid. The grid width of a grid of the microimages or Moiré icons preferably has a value selected from a range of from 5 μm to 300 μm, further preferably from a range of from 5 μm to 50 μm.

The grid of the microimages or Moiré icons has in particular an identical or slightly different, in particular different, grid width compared with the grid width of the microlens grid. The grid of the microimages or Moiré icons can be arranged slightly twisted, in particular twisted, relative to the microlens grid or alternatively have a largely identical, in particular identical, alignment to the microlens grid, i.e. have practically no twisting relative to the microlens grid.

The grid of the microimages or Moiré icons can have, corresponding to the microlens grid, several partial grids, wherein within a partial grid the microimages or Moiré icons are arranged in a one-dimensional arrangement of the microimages or Moiré icons or are arranged in a two-dimensional arrangement of the microimages or Moiré icons. In particular, several partial grids different from each other can be arranged within a grid of the microimages or Moiré icons. For example, at least one partial grid with a two-dimensional arrangement of the microimages or Moiré icons and at least one partial grid with a one-dimensional arrangement of the microimages or Moiré icons can be provided within a grid of the microimages or Moiré icons. The partial grids can have a different outer shape, in particular triangular, polygonal, round, elliptical, motif-shaped, patterned, in the form of a coding. The microimages or Moiré icons can be formed within a partial grid such that for each partial grid an optical effect allocated to the partial grid forms. Several partial grids can thus generate different optical effects, which together, in the grid of the microimages or Moiré icons, reveal a combined optical effect or reveal separate optical effects present next to each other.

For these different optical effects, for each partial grid the microimages or Moiré icons can have in particular differently formed first areas and/or second areas and/or third areas and/or glazing color layers in front of and/or behind the first areas and/or second areas and/or third areas, in particular in perpendicular observation onto the plane spanned by the functional element.

Further, for these different optical effects, for each partial grid the microimages or Moiré icons can have in particular a different number of first areas and/or second areas and/or third areas and/or glazing color layers in front of and/or behind the first areas and/or second areas and/or third areas, in particular in perpendicular observation onto the plane spanned by the functional element.

By microimages is preferably meant here complete motifs and also incomplete motifs, i.e. fragments of motifs. A motif can in particular be selected from or be a combination of: image, symbol, logo, coat of arms, flag, portrait, alphanumeric character.

The subareas are preferably constructed from a plurality of pixels, wherein the pixels are designed as already described above.

Further, the subareas can comprise a plurality of pixels formed of the at least one second area and/or the at least one third area. The subareas preferably have pixels comprising the at least one first area and/or pixels comprising the at least one second area and/or pixels comprising the at least third area. In particular, microimages with a different chromaticity and/or microimages with an achromatically high contrast between foreground and background of a motif are thus possible. For example, microimages comprising pixels with a light white or silver coloring, dark gray or black coloring and/or a golden or coppery coloring are hereby possible.

The subareas can also be designed through the arrangement of the pixels such that a gradual transition from an increased arrangement of pixels comprising the at least one first area to an increased arrangement of pixels comprising the at least one second area is achieved. A recognizable gradual transition from a golden or coppery appearance to a silver appearance is hereby possible. The pixels can here also have an elongated shape, in particular a line shape.

Furthermore, it is possible by combining the preceding embodiment variants to make the golden or coppery color shade of a subarea lighter, i.e. closer to the silver color shade. This can be achieved by arranging the plurality of pixels which do not comprise at least one third area as a mixture, preferably a stochastic distribution, of pixels comprising the at least one first area and the at least one second area.

Alternatively or additionally, a motif of the microimage or a motif made of Moiré icons can be constructed from pixels with a silver reflective appearance and from pixels with a dark gray to black appearance in one zone and be constructed from pixels with a golden or coppery appearance and pixels with a dark gray to black appearance in another zone of the motif. In other words, areas of the motif of the microimage or of the motif made of Moiré icons can be constructed from pixels comprising the at least one second area and from pixels comprising at least one third area and in another area of the motif from pixels comprising at least one first area and pixels comprising at least one third area. Multicolored designs of the functional element are hereby possible, wherein for example golden or coppery movement effects and silver movement effects are present spatially separated from each other in the functional element.

According to a further embodiment of the invention, the at least one glazing color layer is arranged in particular on top of the at least one first, second and/or third area and underneath the plurality of microlenses.

According to a further embodiment variant of the functional element according to the invention, a motif is formed by a plurality of pixels comprising at least the one first area and by a plurality of pixels comprising at least the at least one third area. With respect to the extents of the pixels, reference is made to the above statements. The distribution of the pixels is thus designed such that the motif is perceived by an observer in direct reflection as a grayscale image dyed golden, in particular as a halftone image. The functional element according to the invention hereby further provides the effect that the grayscale image or the halftone image has a color tilt effect in direct reflection or in the zero diffraction order. In particular, the functional element further provides a further surprising latent effect in the first diffraction order in the case of strong tilting, in particular in the at least first areas.

An alternative variant for generating a grayscale image dyed golden in particular as a halftone image is to provide pixels in a planar first area using a high-resolution demetalization method, wherein the metal is removed in this first area. This can be effected using known structuring methods or demetalization methods, such as for example etching methods and/or washing methods and/or exposure methods. With both the metal layer and the demetalized areas being backed by an at least partially planar color layer, the grayscale image can then be made visible with a good contrast. Color mixing effects are additionally possible here.

According to an embodiment example of the invention, the at least one first area can be arranged in a first electrode layer. In particular, the first electrode layer is arranged in a reflective display or can be used in a reflective display. The first electrode layer can comprise further layers or functional elements, such as for example electrically conducting connection components and/or electromagnetic shields and/or thermal shields and/or optical shields and/or circuits.

The first electrode layer hereby has the optical effects generated by the at least one first area.

Further, it is advantageous if a switchable layer, for example an electrochromic layer or a liquid-crystal layer or a PDLC (polymer dispersed liquid crystal) layer, is arranged on top of the first electrode layer. This switchable layer is characterized in that its appearance can be changed through the application of a voltage. In particular if no voltage is applied, for example a PDLC layer appears cloudy to an observer or it appears transparent as long as a voltage is applied. The thickness of the switchable layer is typically in the range of from 2 μm to 20 μm.

Further, a second electrode layer can be arranged on top of the first electrode layer and/or the switchable layer. The second electrode layer is preferably designed transparent or semitransparent and/or transparent and/or has, in particular in the wavelength range of from 400 nm to 700 nm, a transmittance of at least 50%, preferably of at least 75%, further preferably of at least 90%. Examples of such a transparent second electrode layer are a printed poly(3,4-ethylenedioxythiophene) polystyrene sulfonate (PEDOT:PSS) layer or also a structured, preferably finely structured, metal layer appearing transparent to the human eye. For example, such a finely structured metal layer can consist of a metal mesh and/or of a metal grid, which is constructed from metal tracks approx. 5 nm to 100 nm wide, running in the x- and in the y-direction, which have a distance from each other of for example from 50 nm to 1000 nm. Due to the intersections of the mesh, the total surface area of the metal mesh is connected in an electrically conductive manner.

The first electrode layer is expediently arranged underneath the second electrode layer. In other words, the first electrode layer is arranged on the side of the second electrode layer facing away from an observer. In particular, the switchable layer is arranged between the first and the second electrode layer.

The properties of the at least one first area could hereby advantageously be integrated in a reflective display. In particular, the optical effect of the switchable layer can be combined with the color effect of the lower electrode layer. Thus, in the case of a reflective display with a switchable layer, for example a PDLC layer, in particular in a subarea of the display which switches from cloudy to transparent due to the application of an electrical voltage, the golden or coppery color impression of the first electrode layer becomes visible or at least visible to an increased degree. However, if no voltage is applied to the reflective display, the at least one first area is substantially invisible or at least only weakly visible. A functional element in a reflective display is thus obtained which is substantially only recognizable to an observer as long as a corresponding voltage is applied to the reflective display.

In particular, the switchable layer can contain a dye and/or be dyed, whereby, in addition to the optical switching function, it also obtains a color filter function. This provides the advantage that the appearance of the switchable layer when the voltage is applied changes from the color of the dye to the golden or coppery color of the lower electrode layer in the case of applied voltage. The design possibilities are thus still further increased.

The pigmentation level and/or the proportion by volume of the dye of the switchable layer is preferably less than 15%, preferably less than 10%, further preferably less than 5%. The dye of the switchable layer is preferably a soluble dye or insoluble nanoparticles.

According to a further embodiment variant of the functional element according to the invention, this is formed as a sensor element, for example for detecting a substance to be detected and/or changing environmental conditions, such as pressure, temperature, light incidence, electrical voltage and/or current. For this, a preferably polymeric sensor layer is in particular arranged on the side of the metal layer facing the observer. The sensor layer is formed as already explained above. The dye and/or luminescent substance is arranged in the sensor layer, wherein the dye is preferably chromogenic, preferably thermochromic and/or photochromic and/or pH-sensitive.

This leads to the advantageous effect that the sensor layer changes its refractive index and/or absorption coefficient in the sensor area if it comes into contact with a sufficient quantity of the substance to be detected. This leads to an alteration of the color impression perceptible to the human eye. Because of the increased absorption of the dye on the surface of the at least one metal layer with the first relief structure, this alteration of the color impression is already recognizable in the case of relatively low concentrations of the substance to be detected. The enhancement mechanism is called plasmon-enhanced absorption. The alteration of the color impression perceptible to the human eye is here much greater compared with a metal layer with the sensor layer which does not have a relief structure.

Further, it is possible for a preferably dielectric contrast layer to be arranged in areas, seen from an observer, on top of the sensor layer, with the result that it preferably covers at least subareas of the sensor layer and prevents a contact with the substance to be detected and/or the influence of the change in the environmental condition. The contrast layer preferably has a refractive index which is close to the refractive index of the medium which contains the substance to be detected. The refractive index of the contrast layer preferably differs from the refractive index of the medium which contains the substance to be detected by up to ±10%, further preferably by up to ±5%, and still further preferably by up to ±2%.

The region in which the at least one first relief structure, the metal layer and the sensor layer, but not the contrast layer is preferably arranged thus forms a sensor area which is preferably in contact with the medium containing the substance to be detected and/or is exposed to the influence of the change in the environmental condition.

The function of this contrast layer is to protect the covered subareas of the sensor layer from the contact with the substance to be detected and/or from the influence of the environmental conditions, in order that these areas do not exhibit the change in the color impression triggered by the substance to be detected. The contrast layer thus provides the advantageous effect that the contrast between the areas with color change and without color change is particularly easily perceptible to the human eye.

It is also possible for the functional element further to have a filtering transparent, in particular an open-pored, layer which is arranged on top of the sensor layer, seen from an observer. The filtering layer is in particular arranged in the sensor area. Further, the filtering layer is in particular permeable for the substance to be detected present in the medium and prevents other substances present in the medium from reaching the sensor layer. Further, this makes it possible to reduce or prevent undesired reactions of the sensor layer with other substances likewise present in the medium. Optionally, another, preferably polymeric, sealing layer is provided, which prevents the medium from escaping at the edges of the sensor element. The preferably polymeric sealing layer is thus not permeable for the medium and is preferably chemically inert with respect to the medium.

It is also possible for the functional element to have a vertically running channel, preferably in the form of a microfluidic system. The channel is preferably formed by the preferably polymeric sealing layer and can optionally be sealed by further preferably polymeric sealing layer. The polymeric sealing layer is preferably formed transparent. The medium is hereby guided past the sensor area in the channel.

The production of a functional element, in particular a sensor element, can be realized as follows. The first relief structure can be created by means of known methods such as holographic two-beam exposure or by means of e-beam lithography on a glass substrate. A nickel shim with the first relief structure can be obtained herefrom according to known state of the art by means of a galvanic copying process. The nickel shim can be duplicated according to known methods and then the first relief structure can be produced in roll-to-roll methods, for example thermal replication or UV replication, in a flexible film.

Among other things, it can be advantageous for a functional element, preferably for a sensor element, if the first relief structure is realized on a rigid substrate, for example a glass substrate or a quartz substrate. This makes it easier to handle for example liquid media. For this, the first relief structure can be copied from the nickel shim in a UV copying process directly onto the rigid substrate, for example glass substrate or quartz substrate. Known processes for this use so-called sol-gel materials, such as for example ormocer, which are applied to the rigid substrate in liquid form. The nickel shim is then placed on the rigid substrate, for example the glass substrate or the quartz substrate, with the result that a thin film of the sol-gel material remains between the rigid substrate and the nickel shim. This is followed by the curing of the sol-gel material by means of UV radiation through the rigid substrate, for example glass substrate or quartz substrate, as well as the detachment of the nickel shim.

The metal layer can then be vapor-deposited or sputtered in vacuum onto the surface of the cured sol-gel layer with the first relief structure. The sensor layer can then be applied to the metal layer, for example by means of spin coating, as a thin layer.

Alternatively or additionally, during the production of the functional element according to the invention, a subarea of the functional element, in particular the at least one first area, can preferably be stamped onto a substrate by means of a stamping die formed patterned. Further, it is also possible for the functional element to be applied to a substrate over the whole surface by means of a nonspecific laminating roller. It is further particularly advantageous here if the surface of the substrate onto which the functional element is stamped has a surface structure, for example a matte structure, and the stamping pressure is chosen such that the base surface of the first relief structure is deformed according to the surface structure during the stamping.

Further, it is also possible to process the functional element in one work step with a blind stamping tool in the stamping surface of which a surface structure is molded.

The stamping pressure is chosen here such that the base surface of the first relief structure is deformed according to the surface structure of the blind stamping tool during the pressing the blind stamping tool. Through this method it is also possible to individualize the functional element afterwards in a later work step by corresponding deformation of the base surface of the at least one first relief structure and thus to introduce the additional optical effects already described above into the functional element or into a product which has the functional element.

The use of the functional element in a product, for example a security document or a decorated surface, has proved to be particularly good. Thus, the functional element can be arranged in the product for example depending on the design such that it is observed in a top view, but also via a window area, with the result that it can be observed in a top view and a through view.

The above-mentioned characteristics can of course be used in an equivalent manner in a method, or mentioned method features can be used in a product.

In the following, the invention is explained by way of example with reference to several embodiment examples with the aid of the accompanying drawings. The embodiment examples shown are therefore not to be understood as limitative.

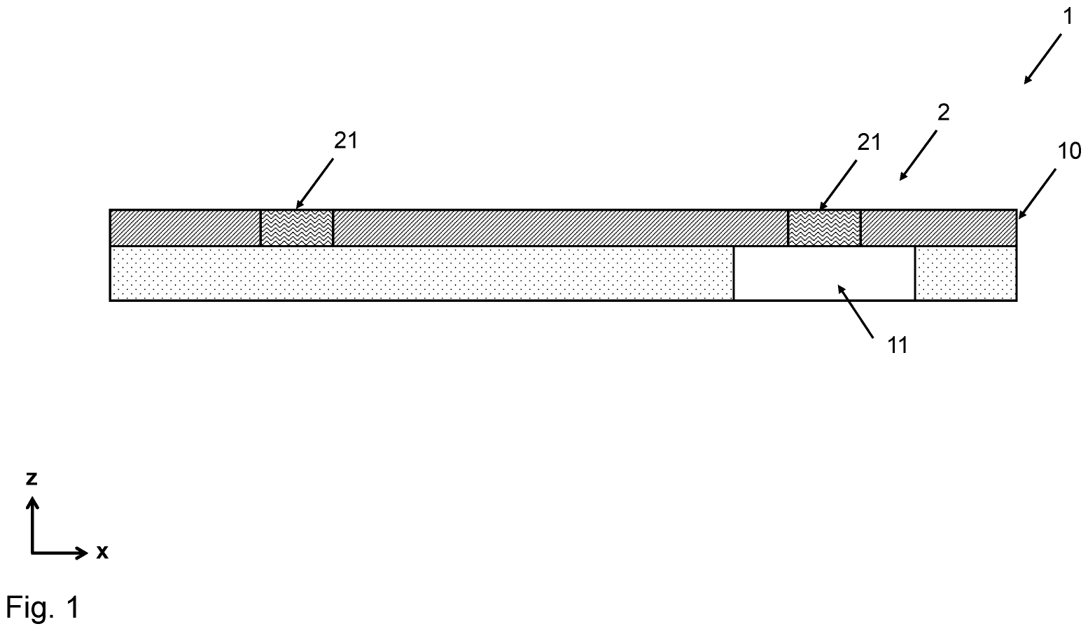

FIG. 1 shows a schematic sectional representation of a product comprising a functional element.

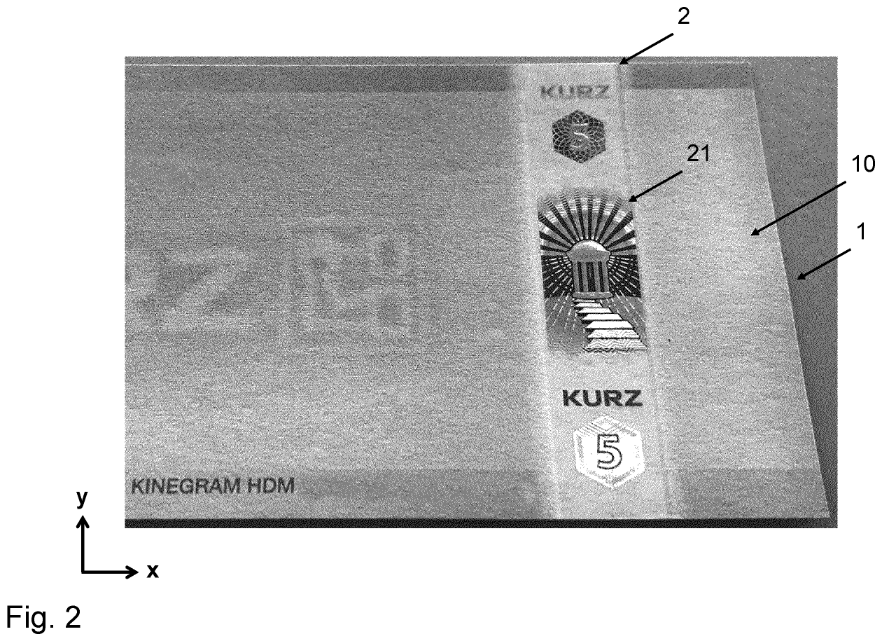

FIG. 2 shows a detail of a product comprising a functional element.

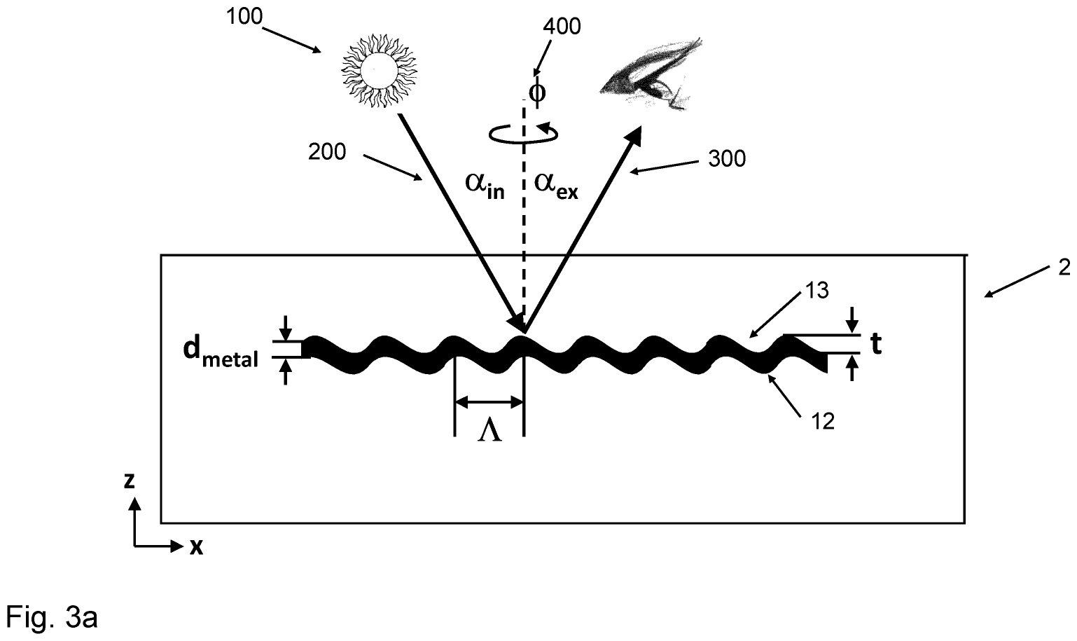

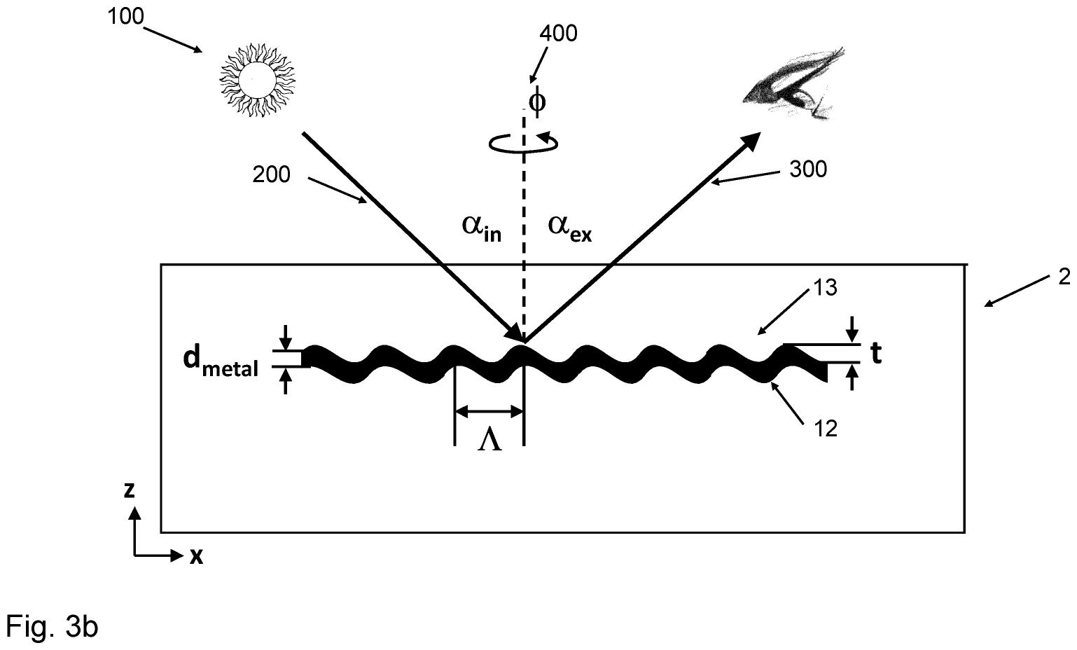

FIGS. 3a and 3b show a schematic sectional representation of a functional element.

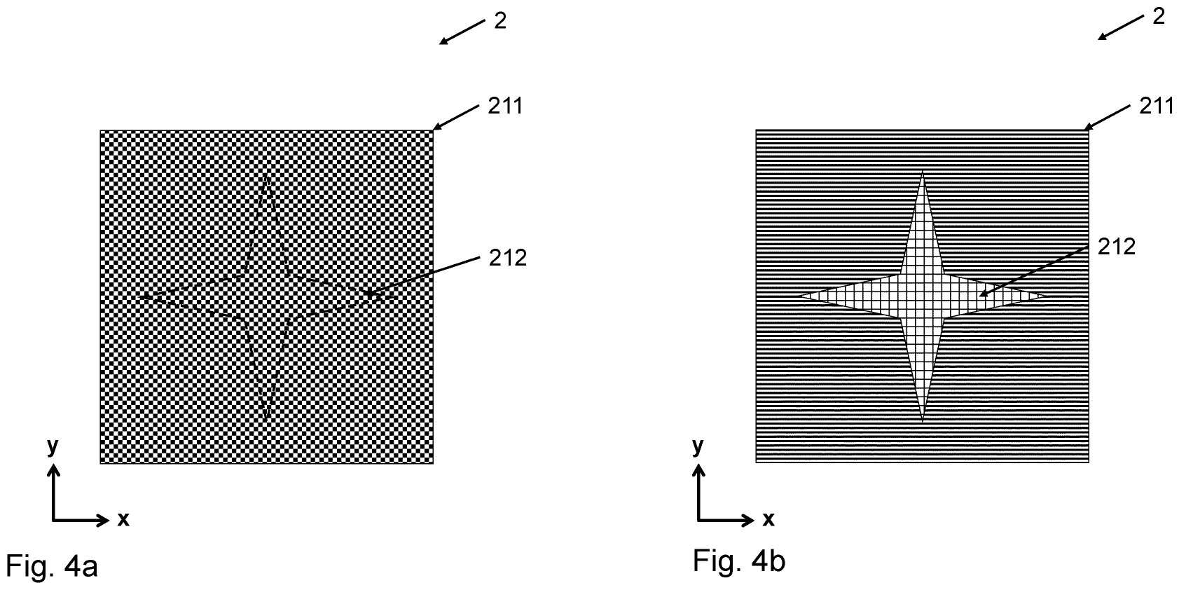

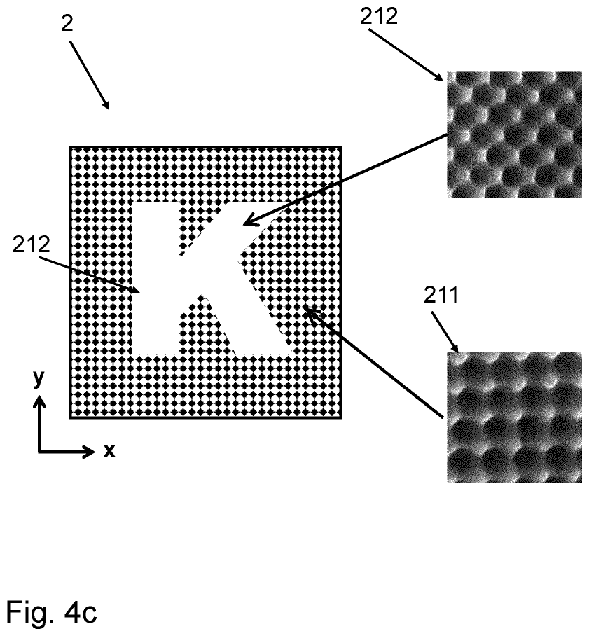

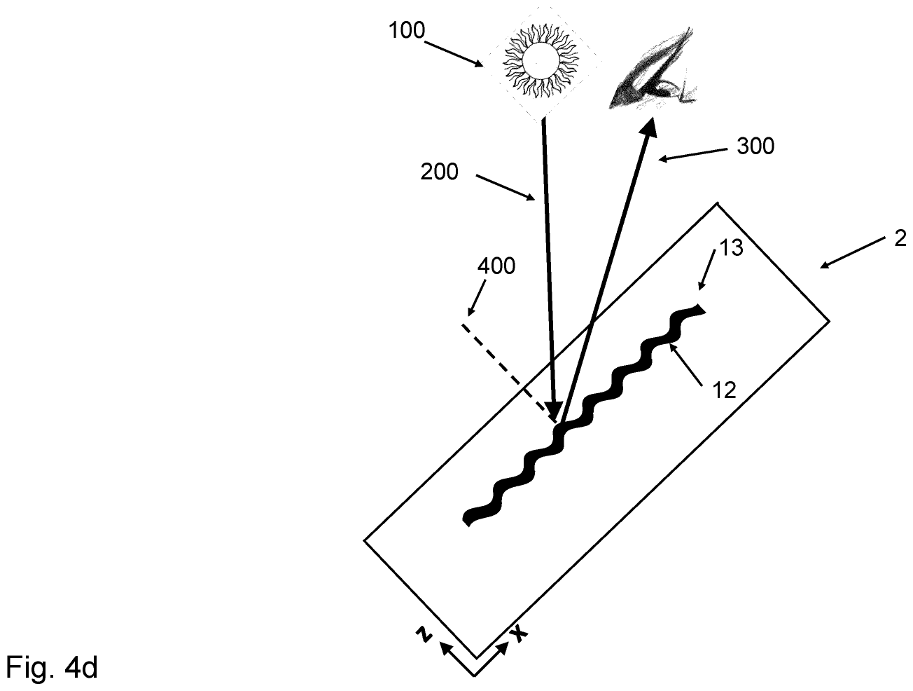

FIGS. 4a, 4b and 4c show schematic top views of functional elements.

FIG. 4d shows a schematic sectional representation of a functional element.

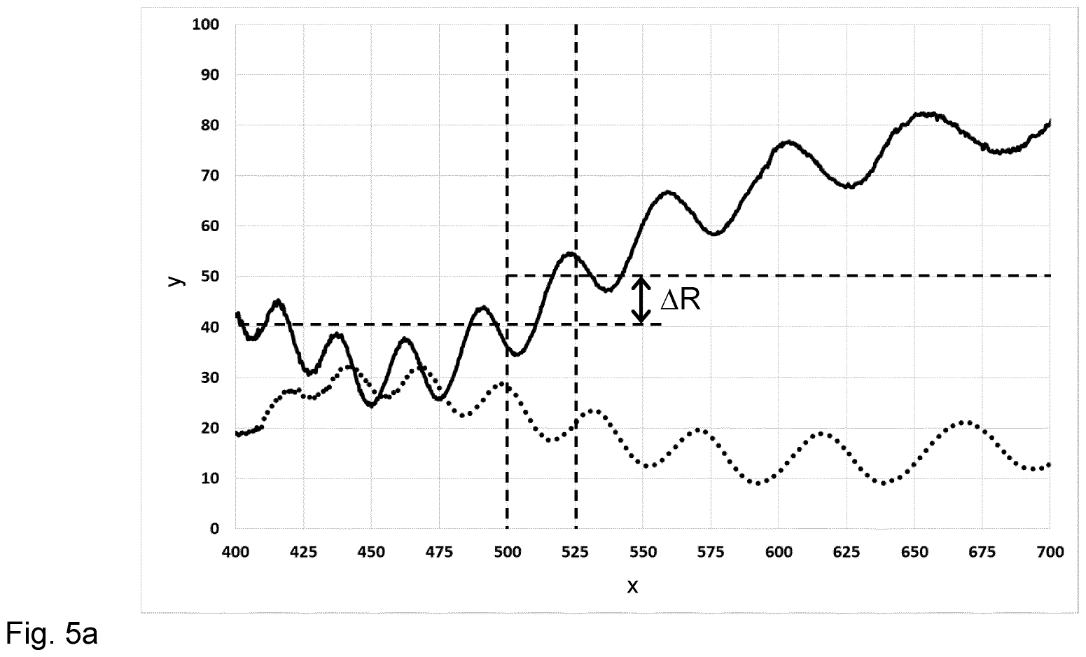

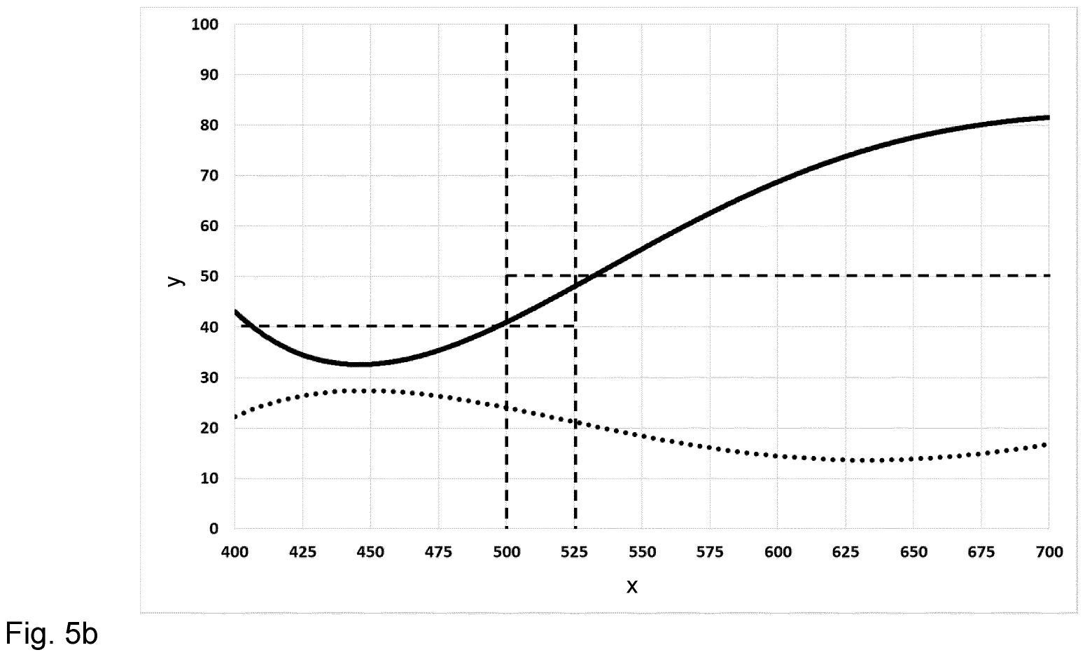

FIGS. 5a and 5b show reflection spectra.

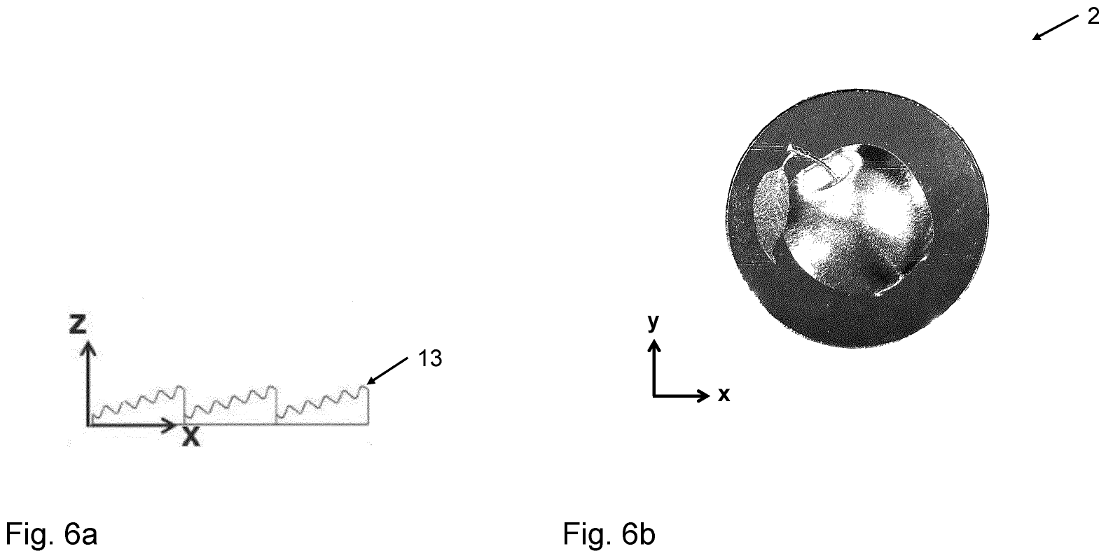

FIG. 6a shows a schematic relief structure.

FIG. 6b shows a top view of a functional element.

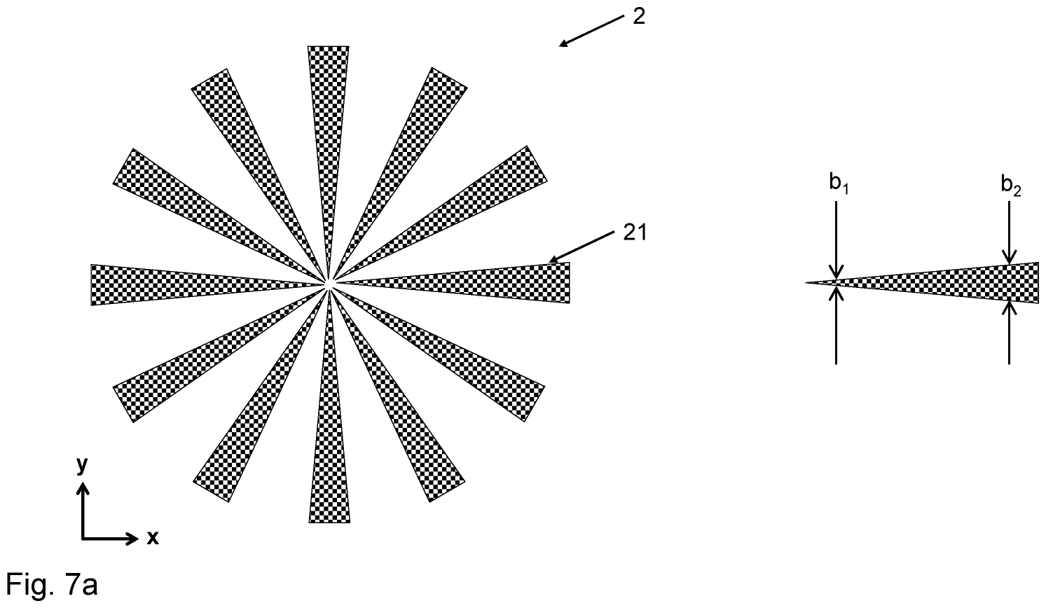

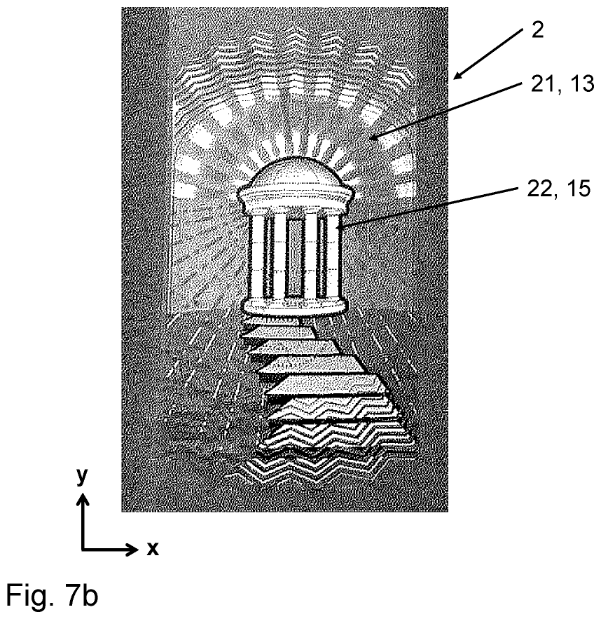

FIG. 7a shows schematic top views of a functional element.

FIG. 7b shows a top view of a functional element.

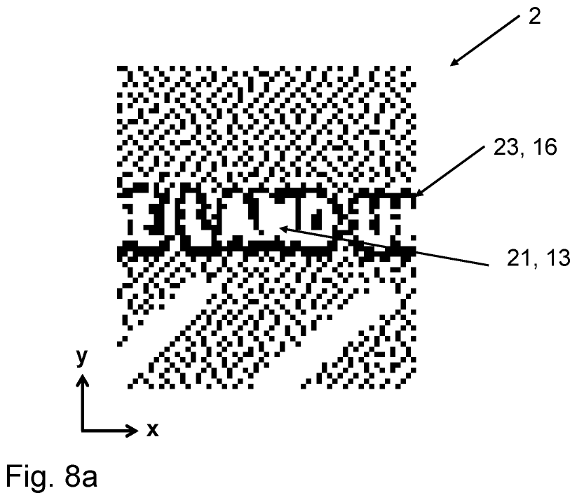

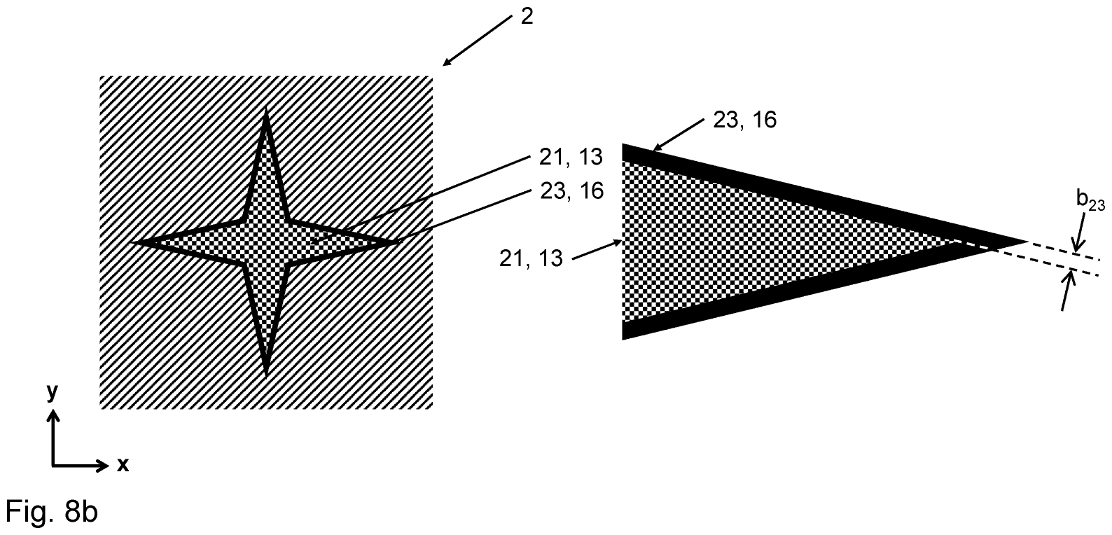

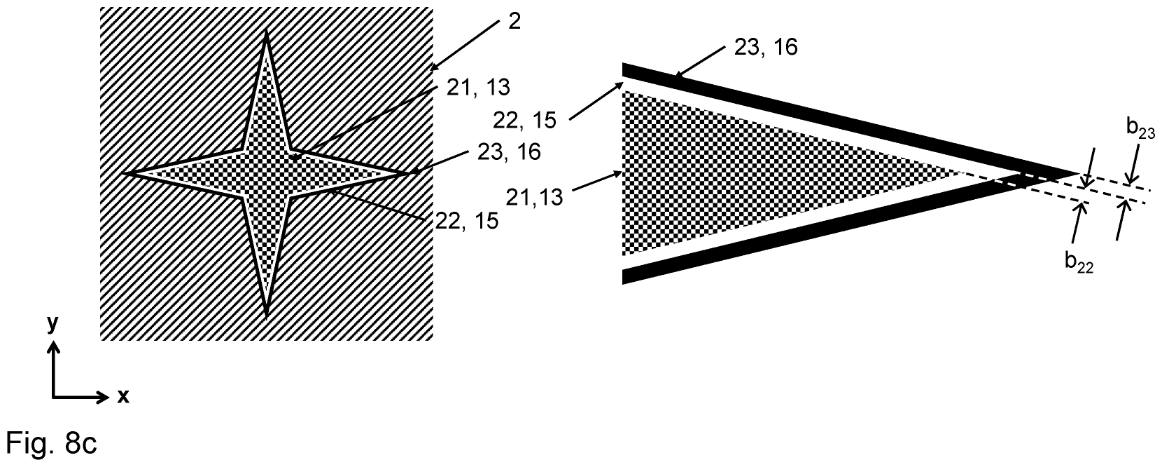

FIG. 8a shows a detail of a functional element.

FIGS. 8b and 8c show schematic top views of a functional element.

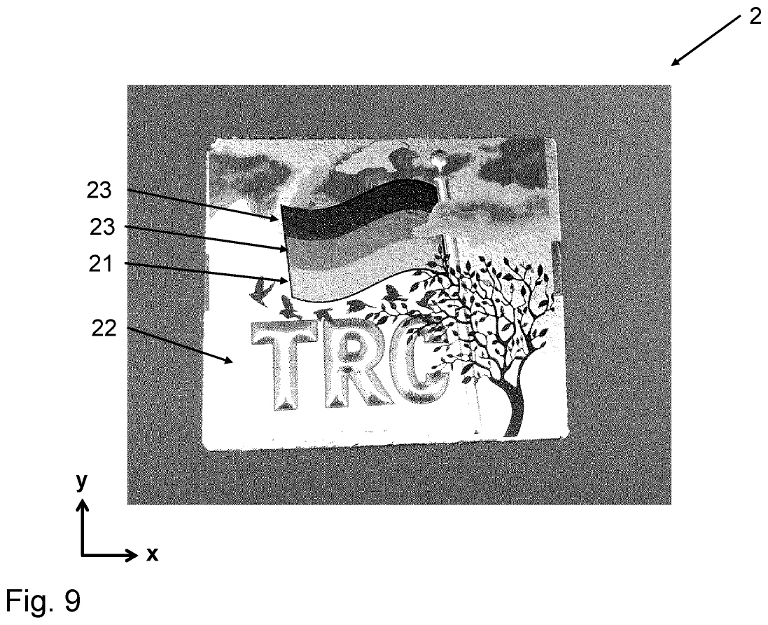

FIG. 9 shows a top view of a functional element.

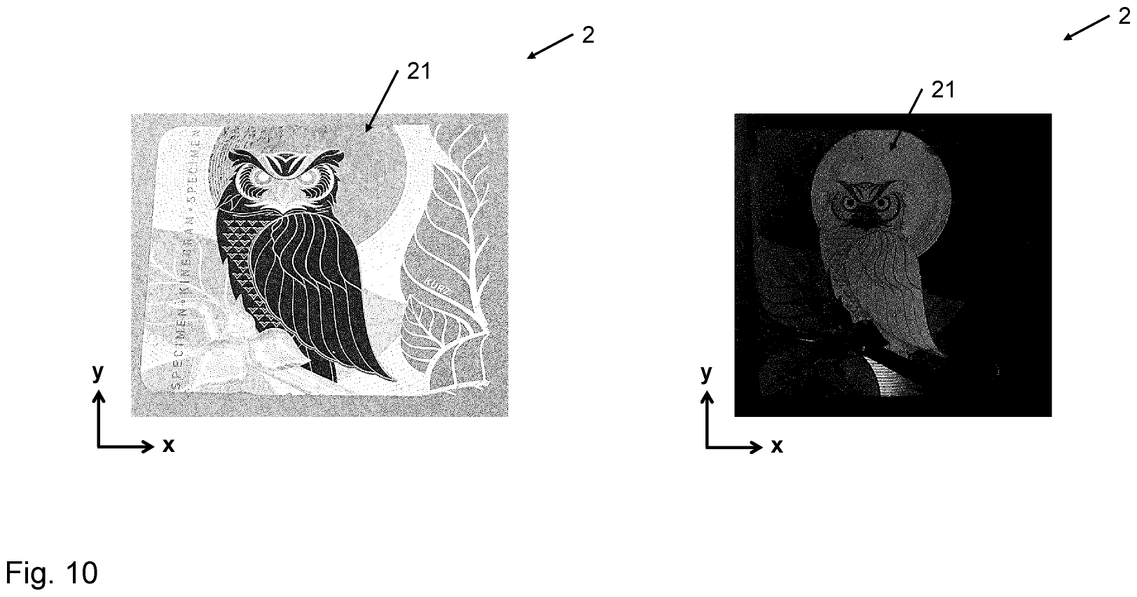

FIG. 10 shows two top views of the same functional element in reflected light observation and in transmitted light observation.

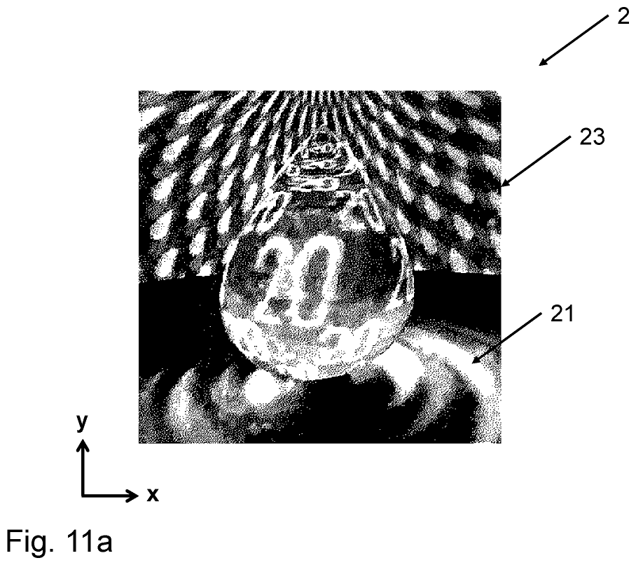

FIG. 11a shows the top view of a functional element.

FIGS. 11b and 11c show schematic top view of a functional element.

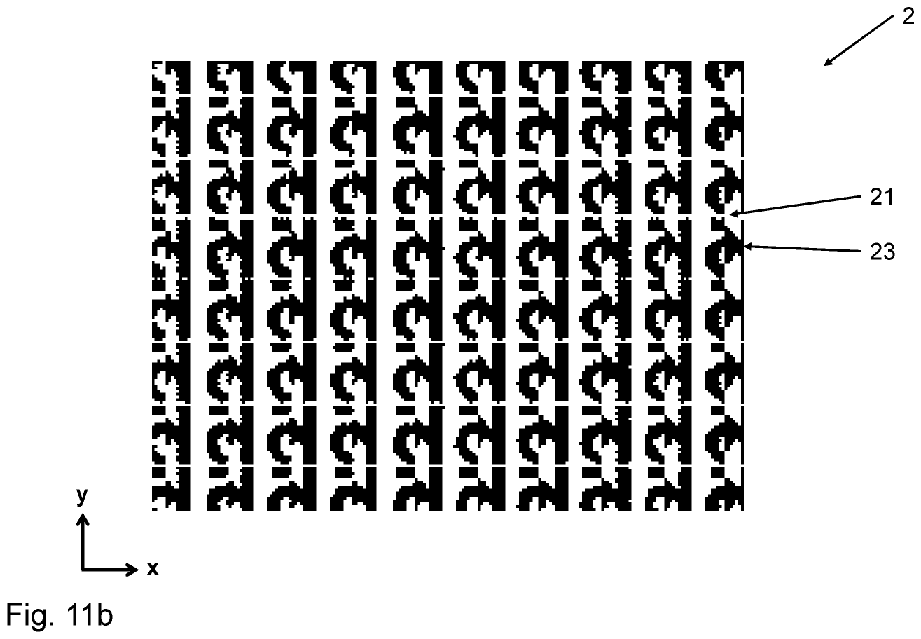

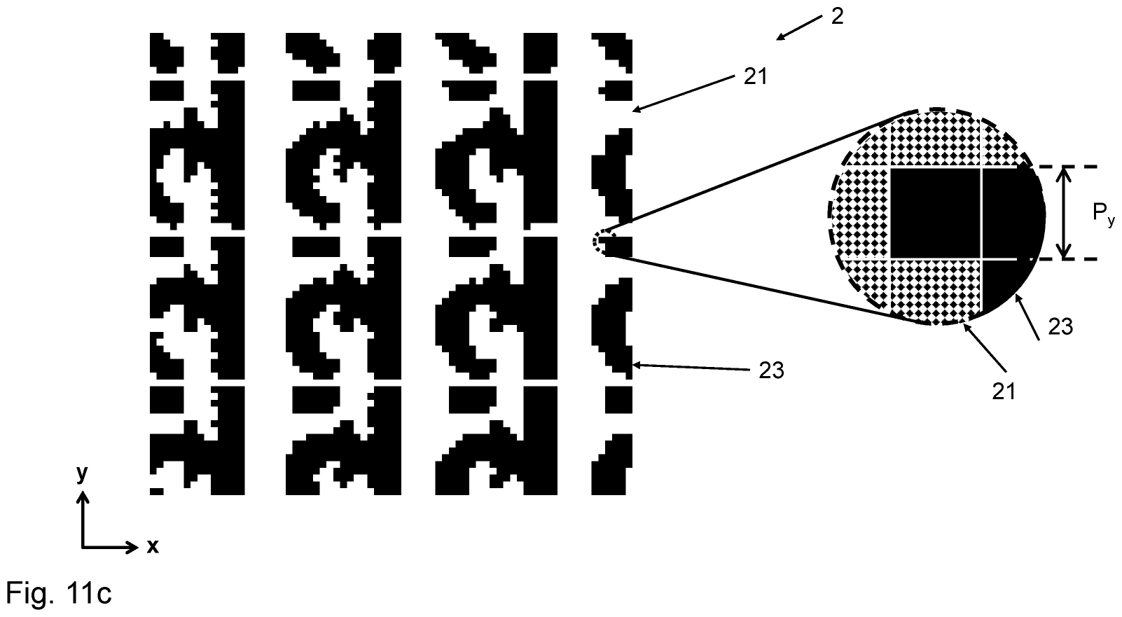

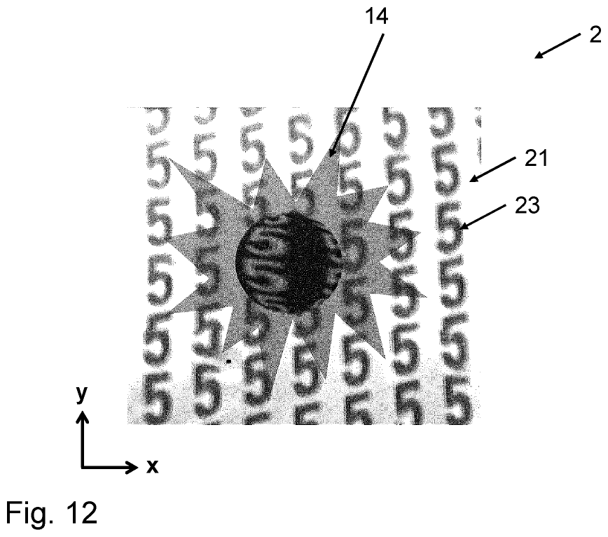

FIG. 12 shows a top view of a functional element.

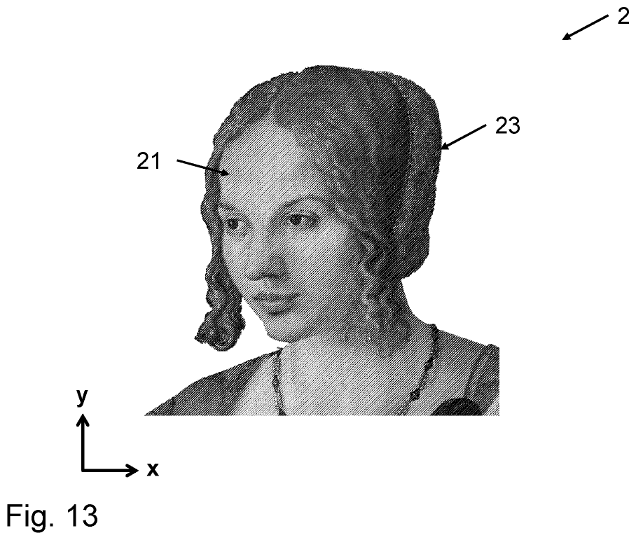

FIG. 13 shows a top view of a functional element.

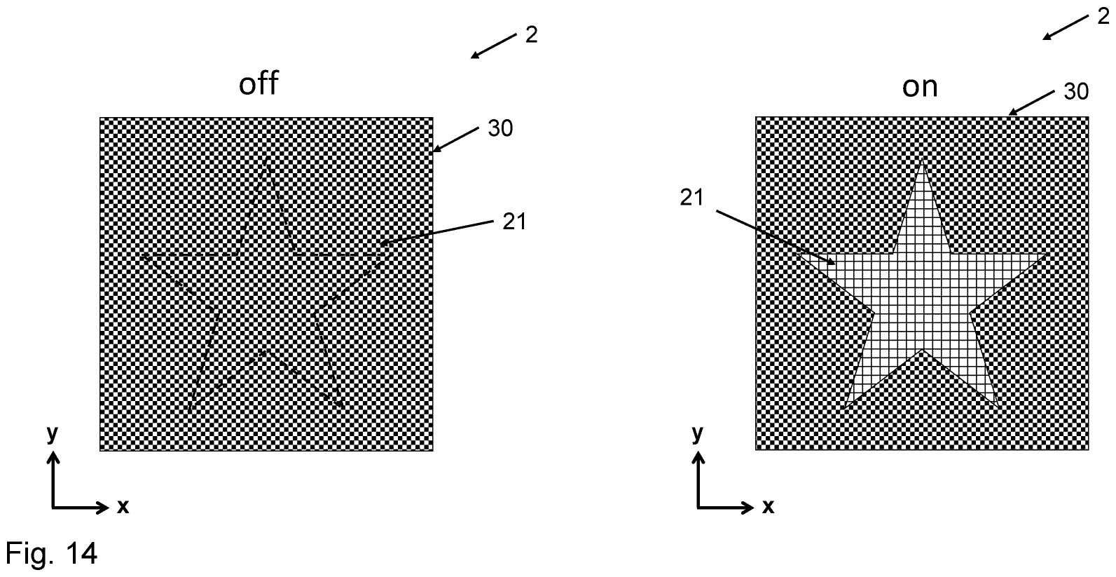

FIG. 14 show schematic top views of a functional element.

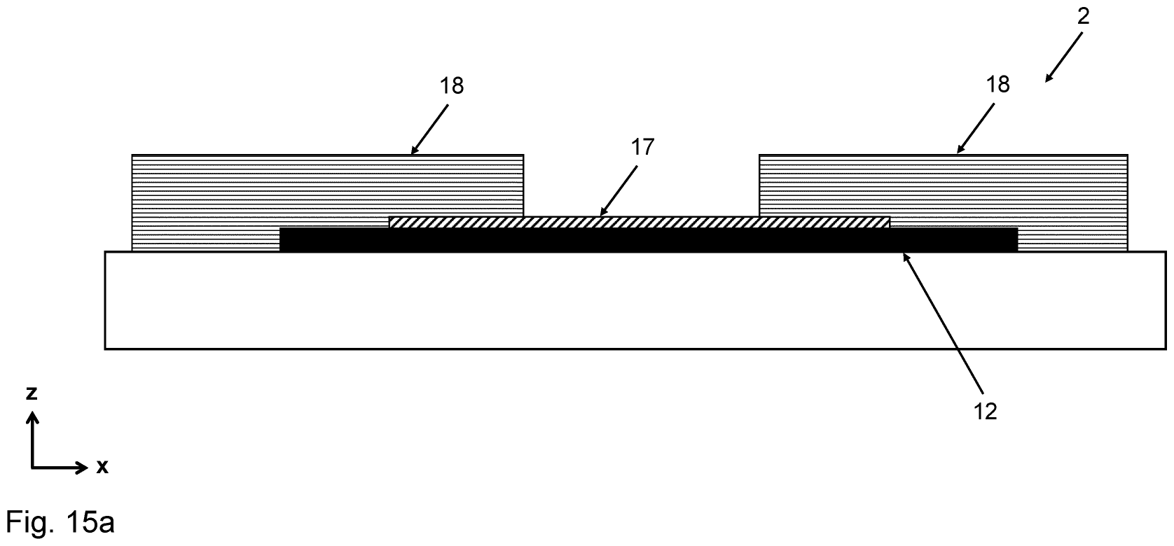

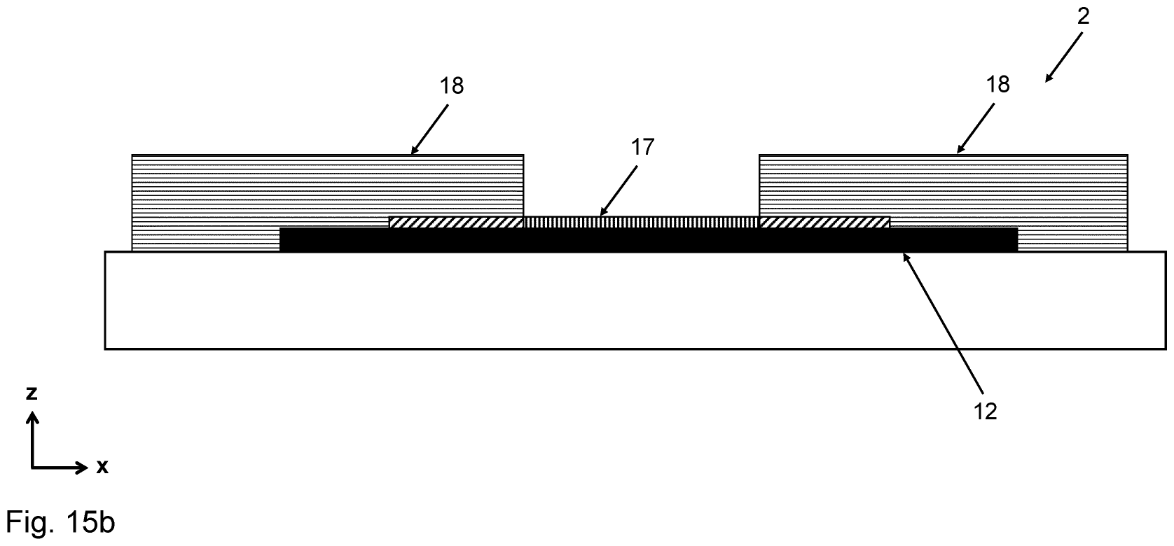

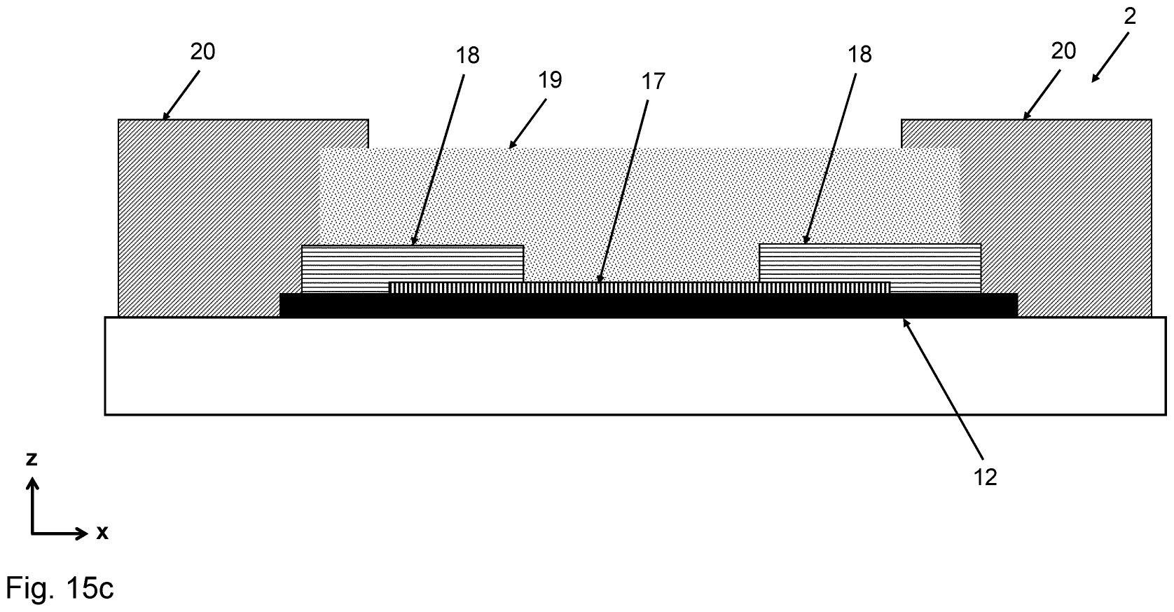

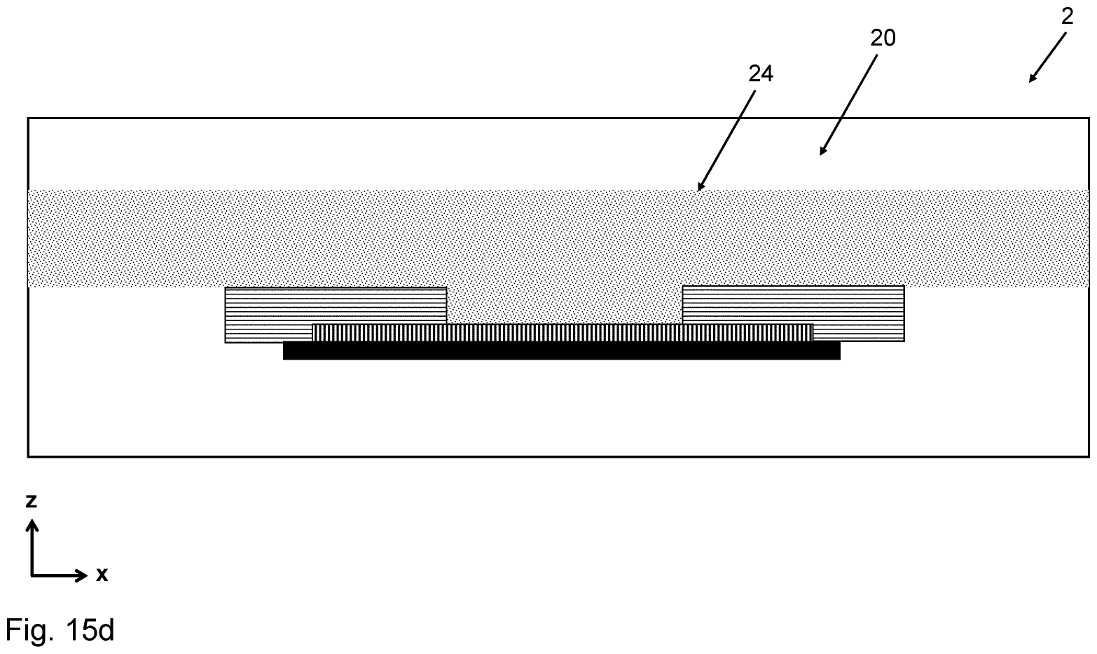

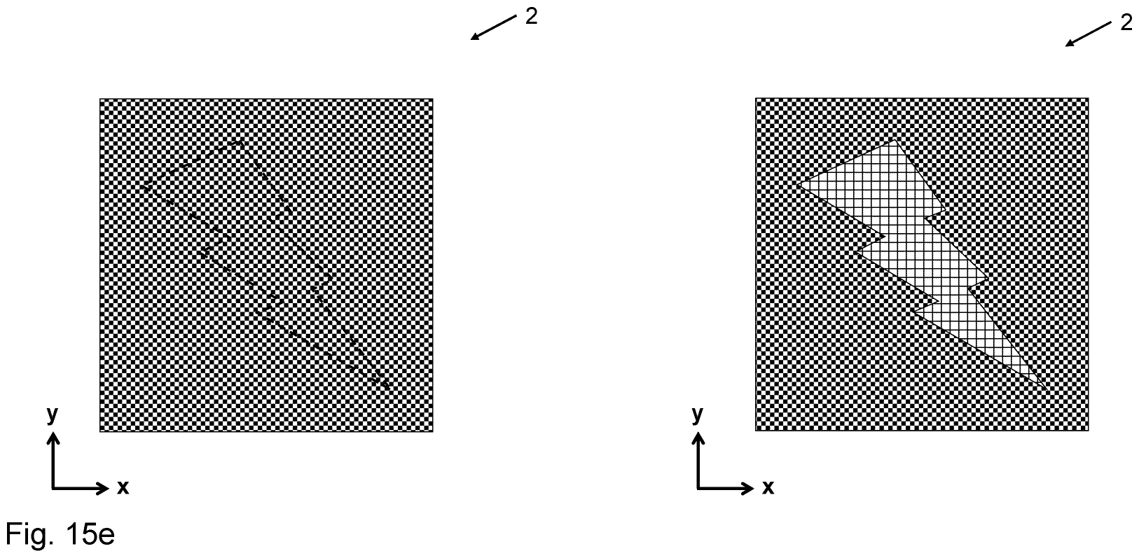

FIGS. 15a to 15d show a schematic sectional representation of a functional element.

FIG. 15e shows a schematic top view of a functional element.

FIG. 16 shows a schematic top view of a functional element.

FIG. 17 shows a schematic sectional representation of a functional element.

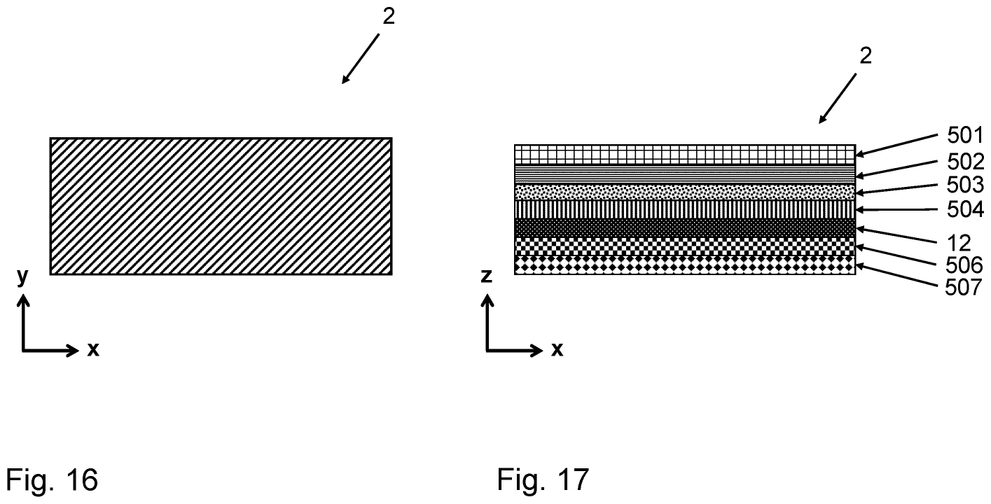

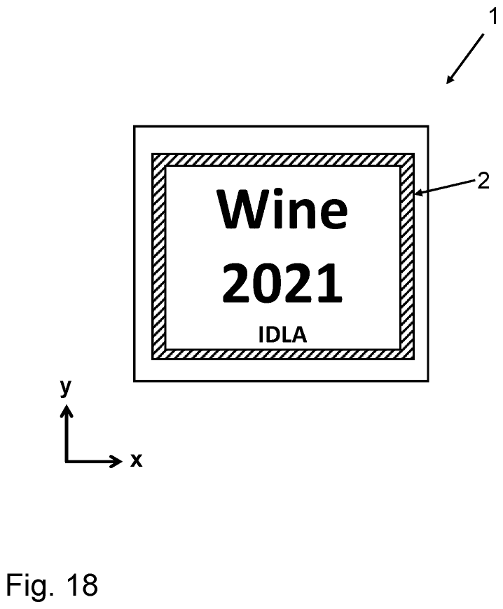

FIG. 18 shows a schematic representation of a product comprising a functional element.

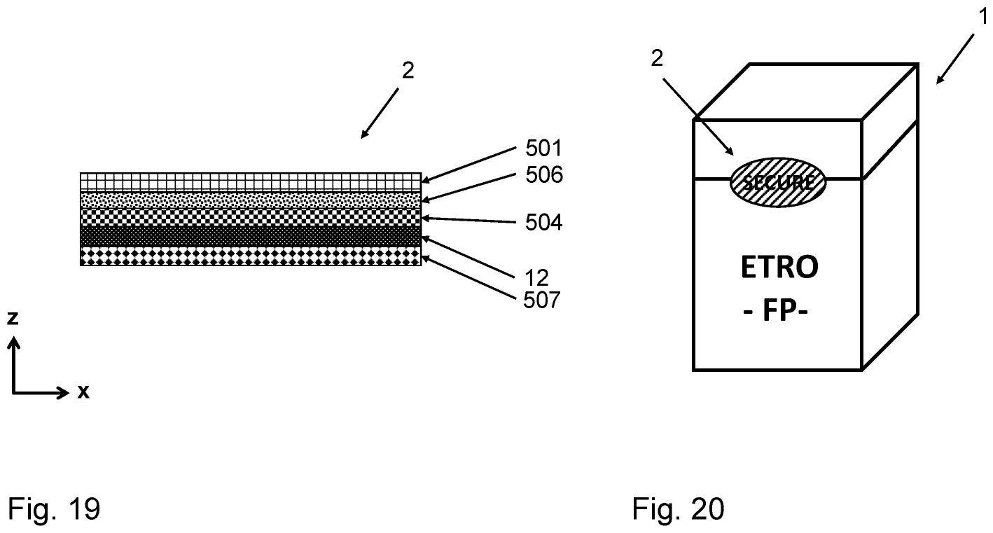

FIG. 19 shows a schematic sectional representation of a functional element.

FIG. 20 shows a schematic representation of a product comprising a functional element.

A sectional representation of an example product 1 comprising a functional element 2 is represented in FIG. 1. FIG. 2 in turn shows an embodiment example of a product 1 comprising a functional element 2, for example according to the sectional representation from FIG. 1.

The product 1 comprising a functional element 2 according to FIG. 1 or FIG. 2 is for example a banknote. However, it is also possible for the product 1 to be for example an ID document, a label for product security or for decoration, an ID card or credit card, cash card, a hang tag of a commercial product or a certificate, in particular software certificate, a packaging, a component part for stationary and/or mobile devices, an injection-molded component part, a directly structured aluminum component part, a motor vehicle, a decorative trim, a color filter, a sensor, an optical component part, a light control. The following statements are thus not restricted to a banknote, but can equally be applied to the further above-named embodiments of the product 1.

The product 1 here has a carrier substrate 10 and a functional element 2 applied to the carrier substrate 10.

The carrier substrate 10 is preferably a paper substrate, for example with a layer thickness in the range of from 50 μm to 500 μm. However, it is also possible for the carrier substrate 10 to be a plastic substrate or a carrier substrate made of one or more plastic and/or paper layers. Furthermore, it is also possible for, in addition to the functional element 2, one or more further functional elements also to be applied to the carrier substrate 10 or to be integrated in the layer structure or the layers of the carrier substrate 10. The carrier substrate 10 can thus have for example one or more of the following elements as further functional elements: watermark, security print, security thread, antenna, chip, patch or strip with at least one security feature, comprising holographic or optically diffractive structures.

The functional element 2 has at least one first relief structure 13 in a first area 21, as well as a metal layer 12 arranged in at least one subarea of the at least one first relief structure 13 and optionally a preferably polymeric dielectric layer on the side of the metal layer which faces the observer.

The at least one metal layer 12 is preferably made of aluminum and/or silver and/or palladium and/or platinum and/or alloys thereof. In particular, the at least one metal layer 12 is formed of aluminum or an alloy with an aluminum proportion by weight of more than 70%, preferably of more than 90%. The at least one metal layer 12 is preferably vapor-deposited and/or sputtered in vacuum in the at least one first subarea of the at least one first area 21.

Alternatively, the metal layer 12 can also be applied over the whole surface first and then removed again in the areas which are to have no metal. This can be effected using known structuring methods or demetalization methods, such as for example etching methods and/or washing methods and/or exposure methods.

It is also possible to stamp the structures according to the invention into the surface of metal layers and/or of metal foils and/or of metal bodies, and/or to inscribe the structures according to the invention into surfaces by means of lasers (for example by means of femtosecond lasers).

According to a preferred embodiment example of the invention, the layer thickness dₘₑₜₐₗ of the at least one metal layer 12 is chosen such that it has an optical density (OD) selected from a range of from 0.9 to 3.0, preferably from 1.1 to 2.5, further preferably from 1.6 to 1.9. In particular for an observation of the functional element in transmission, it is advantageous if the metal layer has an optical density (OD) selected from a range of from 1.6 to 1.9. It is hereby achieved that sufficient light intensity, in particular for the observation of the functional element in transmission, passes through the area with the structure according to the invention.

Simultaneously, areas which in particular no structure or structures which allow much less light to pass through a metal layer appear sufficiently dark in order to generate a contrast easily perceptible to the human eye.

The functional element is preferably designed such that one or more layers of the functional element 2 possibly arranged on top of and/or underneath the at least one metal layer 12 and/or one or more layers of the functional element 2 possibly provided underneath the at least one metal layer 12 are formed transparent or semitransparent, in particular have a transmittance, in particular in the wavelength range of from 400 nm to 700 nm, of at least 10%, preferably of at least 25%, further preferably of at least 75%, still further preferably of at least 90%, in at least one subarea of the at least one first area 21.

The functional element 2 is for example a transfer film, a label film, a laminating film or a security thread. Furthermore, the functional element 2, in particular the at least one first area 21, can preferably have another one or more further layers selected from the group: replication layer, dielectric layer, layer made of a dye, layer made of a luminescent substance, glazing color layer, mask layer, polymer layer, metal layer, protective varnish layer, adhesive layer, detachment layer, primer layer, barrier layer, porous layer, contrast layer, sealing layer, adhesion-promoter layer, carrier layer, decorative layer. The above-named layers can in each case be arranged individually or also in any desired combination with each other in the functional element, in particular in the at least one first area 21, on top of and/or underneath the at least one first relief structure 13. The layers can be applied here over the whole surface as well as only partially, i.e. in areas. For example, one or more of the layers can be arranged patterned. Several patterned layers can also be arranged in register with each other.

The functional element 2 according to the invention thus has for example a carrier film, preferably a transparent plastic film preferably made of PET, PC, PE, BOPP with a thickness of between 10 μm and 500 μm, a transparent replication layer, preferably made of a thermoplastic or UV-curable replication varnish, an adhesive layer, preferably a cold adhesive layer, a hot adhesive layer or a UV-curable adhesive layer and a polymer layer, preferably made of known varnish systems with a refractive index in the range of from 1.45 to 1.55.

Further, the functional element 2 according to the invention preferably has no additional thin layers made of high-refractive-index materials such as ZnS or TiO₂ or no polymeric varnish layers filled with, in particular, high-refractive-index nanoparticles which are arranged in particular on top of and/or underneath the at least one metal layer 12.

Further, it is advantageous if a dielectric layer, for example made of low-refractive-index material such as MgF₂ and/or of a low-refractive-index polymer layer, is arranged on top of and/or underneath the at least one metal layer 12. The dielectric layer is preferably printed or vapor-deposited such that it is arranged on the surface of the at least one metal layer 12 over the whole surface or in areas. A low-refractive-index layer has in particular a refractive index of at most 1.45.

According to a preferred embodiment example of the invention the functional element 2 has at least one dye and/or one luminescent substance, which is in particular arranged in a layer, in the first areas 21 or in the at least one first area 21. The dye and/or luminescent substance is preferably arranged less than 1 μm, further preferably less than 750 nm, still further preferably less than 500 nm, furthermore still further preferably less than 300 nm, away from one of the surfaces of the at least one metal layer 12. The dye and/or the luminescent substance is preferably arranged in the dielectric layer or a polymeric layer.

The dye can be applied using a printing method or in vacuum. Examples of vacuum-applied dyes are Patinal Black A or Brown A from Merck as well as metals absorbing light in the visible spectral range, preferably in the wavelength range of from 400 nm to 700 nm, such as gold, copper or chromium.

The dye and/or the luminescent substance is preferably arranged on the at least one metal layer 12 only in areas. Further, the dye and/or the luminescent substance is provided only where the at least one metal layer 12 adjoins the at least one first relief structure 13 and thus generates the above-described effect.

When printing methods are used other dyes than those in the case of vacuum-application are preferably used. The dye and/or the luminescent substance is preferably a soluble dye or luminescent substance or insoluble nanoparticles or pigments. Dyes from the following substance groups are preferably used as dye: metal complex dyes, in particular with Cr³⁺ or Co²⁺ as central atom. Luminescent substances selected individually or in combination from the following substance groups are preferably used: coumarins, rhodamines and cyanines.

The pigmentation level and/or the proportion by volume of the dye and/or of the luminescent substance can be up to 100% in the layer containing the dye and/or the luminescent substance, in particular if the dye and/or the luminescent substance is vacuum-applied. The pigmentation level and/or the proportion by volume of the dye and/or of the luminescent substance is preferably more than 50%, and further preferably more than 75%, and in particular preferably more than 90%. In the case of such high pigmentation levels and/or proportions by volume of the dye and/or of the luminescent substance, the dye layer can be designed extremely thin, whereby the dye and/or the luminescent substance is present maximally close to the metal layer.

The pigmentation level and/or the proportion by volume of the dye and/or of the luminescent substance of the layer, applied in the printing method, containing the dye and/or the luminescent substance is preferably less than 15%, preferably less than 10%, further preferably less than 5%, in particular if dyes and/or luminescent substances are used which, without a stabilizing matrix, e.g. made of polymer, would not have a sufficient adhesion to the metal layer and/or would bring about a chemical reaction with the metal layer. Mixtures of different pigments and/or dyes and/or luminescent substances can also be used.

The layer containing the dye and/or the luminescent substance is preferably transparent and/or has a transmittance, in particular in the wavelength range of from 400 nm to 700 nm, of at least 10%, preferably of at least 25%, further preferably of at least 75%, still further preferably of at least 90%. It is herewith guaranteed in particular that if the dye is also applied in subareas in which no relief structure and no metal layer is arranged no substantial dyeing of an underlying layer is recognizable.

Through the arrangement of the dye and/or of the luminescent substance, the generated first color impression can be altered in a targeted manner in particular in direct reflection. For example, it is possible for the dye and/or the luminescent substance to have an absorption maximum in the case of a wavelengths of 550 nm, wherein the absorption has a Gaussian distribution with a width selected from a range of from 25 nm to 100 nm, preferably from 40 nm to 60 nm. As this would lead to a deep slump in the reflectance at 550 nm, arranging such a dye and/or luminescent substance results in a reddish first color impression.

The dye and/or the luminescent substance can be provided over the whole surface or also only partially in individual areas of surface. Through a partial application in areas of surface it is achieved that the first color impression is to be observed only in the areas of surface with dye and/or luminescent substance and that the first color impression is not present neighboring these, where no dye and/or no the luminescent substance is applied. Designs which generate a contrast of the first color impression with other optical effects can thereby be generated.

Further, it is possible for a glazing color layer 14 to be arranged over the whole surface or partially at least in areas or over the whole surface on the at least one first area 21 or further areas. This glazing color layer 14 can directly adjoin the metal layer 12 or be spaced apart from the metal layer 12 by a dielectric intermediate layer.

The at least one glazing color layer 14 here acts as a color filter and generates a detectable color impression in the corresponding coloring of the color filter for an observer. In addition to the color filter effect, at a correspondingly small distance from the metal layer 12 of preferably less than 1 μm, further preferably less than 750 nm, still further preferably less than 500 nm, furthermore still further less than 300 nm, the glazing color layer can also, as described above, alter the first color impression through greatly increased absorption and/or fluorescence by means of plasmon-enhanced absorption as well as plasmon-coupled emission.

The color impression, detectable for an observer, of the first relief structure and/or of the further relief structures and/or of the mirror surfaces underneath the glazing color layer 14 can be determined as a combination of the optical effects of the corresponding relief structures and/or mirror surfaces with the coloring by the glazing color layer 14.

In particular, the at least one glazing color layer 14 is transparent and/or has a transmittance, in particular in the wavelength range of from 400 nm to 700 nm, of at least 10%, preferably of at least 25%, further preferably of at least 75%, still further preferably of at least 90%.

Two or more glazing color layers 14 can be present next to each other. Alternatively, two or more glazing color layers 14 can also be present overlapping at least in areas.

In the overlapping areas of the two or more glazing color layers 14 a mixed color forms from the colors of the two or more color layers 14 and in particular the underlying at least one first area 21.

The thickness of the at least one glazing color layer 14 is preferably less than 10 μm, preferably less than 5 μm, further preferably less than 2 μm. In particular, the pigmentation level and/or the proportion by volume of the dye and/or luminescent substance of the glazing color layer 14 is less than 15%, preferably less than 10%, still further preferably less than 5%. The dye of the glazing color layer 14 is preferably soluble dyes.

In an embodiment the at least one glazing color layer 14 can be arranged at a distance from one of the surfaces of the at least one metal layer 12 of less than 500 nm, preferably less than 200 nm, still further preferably in direct contact with one of the surfaces at least one metal layer 12.

Further, it is also possible for the at least one first area 21 to have a subarea which is formed patterned and in particular to have a subarea surrounding this subarea.

Further, at least one layer, in particular a mask layer 12, which is formed opaque, can be arranged in the surrounding subarea, with the result that the optical effect generated by the at least one metal layer 12 and the at least one first relief structure 13 is visible only in the subarea of the at least one first area which is not covered by the opaque layer.

In the embodiment example according to FIG. 1 and FIG. 2 the functional element 2 extends for example over at least a width or length of the product 1.

Further, the functional element 2 covers a window area 11 of the carrier substrate 10, in which the carrier substrate 10 has an opening or through-hole or is formed transparent. The functional element 2 or at least a first area 21 comprising at least one first relief structure 13 is thus visible in this area both in the case of observation from the front and in the case of observation from the back of the product 1. Here, in particular, the presence of a different color impression from the front compared with from the back can be checked. For example, in the window area the functional element 2 can appear copper-colored observed from the front and gold-colored observed from the back. The different color impression can be generated by: an asymmetrical grating profile and/or a different refractive index of the dielectric layer on the two sides of the metal layer 12 and/or a dye layer on one of the two sides of the metal layer 12.

Alternatively or additionally, the functional element 2 can have a first area 21, which is not arranged in a window area 12 of the product 1, but rather is applied completely to an opaque area of the substrate 10. Such a functional element 2 can be formed for example in terms of its shaping as a patch or as a strip.

Further, it is also possible for the functional element 2 to be embedded in layers of the carrier substrate 10, in particular if the product 1 is a card-shaped product 1. In this case, the functional element 2 is provided as a patch or strip on one ply of the card-shaped product 1 and then laminated with further plies of the card-shaped product 1, and thus embedded in the card-shaped product 1.

FIGS. 3a and 3b show a detail of a functional element 2 according to the invention, for example according to FIG. 1 or FIG. 2 and are to illustrate different parameters of the profile shape. Thus, the functional element 2 has a first relief structure 13 in at least one first area 21. A metal layer 12 with a layer thickness dₘₑₜₐₗ is also arranged in a subarea of the at least one first relief structure 13 and optionally a preferably polymeric dielectric layer is arranged on the side of the metal layer 12 which faces the observer.

The at least one relief structure 13 has, in at least one direction determined by an allocated azimuthal angle, a sequence of elevations and depressions, the elevations of which succeed each other with a grating period Λ which are smaller than a wavelength of visible light. The one first relief structure 13 further has a relief depth t. The color impression or color effect of the relief structure 13 is visible in direct reflection, thus in specular reflection or on condition that αᵢₙ=αₑₓ, wherein αᵢₙ is the angle of the incident light 100, 200 and αₑₓ is the angle of the reflected light 300, with respect to the surface normal of the base surface or normal 400. Preferably, through corresponding choice of the relief depth t and the profile shape of the relief structure 13, a clearly recognizable color change is further also generated if the angle of incidence and angle of emergence are simultaneously changed for example from a range of from 0° to 30° (see FIG. 3a) to for example an angle of incidence and angle of emergence in the range of from 30° to 60° (see FIG. 3b). The functional element 2 according to the invention is designed such that in the case of such a change from a first angle of incidence to a second angle of incidence a second color impression is perceived instead of a first.

The profile shape and/or the relief depth and/or grating period of the at least first relief structure 13 is preferably further chosen such that in the case of a second angle of incidence different from the first angle of incidence the colored appearance of the light directly reflected in the first subarea or directly transmitted through the at least one metal layer 12 is altered differently.

In particular, a first color impression appears in direct reflection in the case of a first angle of incidence and a second color impression appears in direct reflection in the case of a second angle of incidence, wherein, in particular starting from the normal 400 perpendicular to the base plane of the relief structure 13, the first angle of incidence is selected from a range of from 0° to 30° and in particular wherein the second angle of incidence is larger than the first angle of incidence by a value selected from a range of from 10° to 45°. A defined color change when tilted or a color tilt effect is herewith made possible. At the first or the second angle of incidence in the case of reflected light observation and/or transmitted light observation, in particular different, relatively stable color impressions thus appear in direct reflection for the human observer.

FIG. 4a and FIG. 4b show an example embodiment of the functional element according to the invention which has two first areas 211, 212 with in each case a relief structure 13 and a metal layer 12 arranged on the relief structures. Further, the functional element can optionally have a preferably polymeric dielectric layer, which is arranged on the side of the metal layer which faces the observer. In both first areas 211, 212 the relief structure has the same profile shape and relief depth and grating period. If the functional element 2 in FIG. 4a is observed at a first angle of incidence, then the same first color impression is thus recognizable for an observer in both first areas 211, 212 and the functional element 2 appears single-colored. If the functional element 2 is observed at the second angle of incidence, as represented schematically in FIG. 4b, then a second color impression can be perceived for both areas 211, 212. This second color impression is different from the first, golden or coppery color impression, and is further different for both areas. An observer thus recognizes for example a green star in a first area 212 in front of a magenta-colored background of the further first area 211. This second color impression is in particular dependent on the azimuthal angle of the relief structure 13. Thus, for example, one first area 212 has an azimuthal angle of 0° or 90° and the further first area 211 in contrast has an azimuthal angle rotated or different by at least 15°, preferably by 30° and further preferably by 45°.

For example, for illustration in the embodiment example of a functional element 2 according to FIG. 4c regarding this, a K-shaped first area 212 is designed such that it has an azimuthal angle of 45°, whereas the area 211 surrounding the K-shaped area is designed with an azimuthal angle of 0°. As the two first areas 211, 212 have the same profile shape, relief depth or grating period, the same first color print forms in direct reflection in both first areas at a first angle of incidence and angle of emergence. It is advantageous here that this color tilt effect is structure-based, and thus in perfect register with other structure-based effects.

In the case of a third angle of incidence different from the first and second angle of incidence, preferably in the case of 60° or more relative to the normal 400—as is represented by way of example in FIG. 4d—an optical appearance which is different from the optical appearances of the first and second angles of incidence preferably appears due to the light diffracted into the first diffraction order in the at least one first area 21.

According to a preferred embodiment of the functional element according to the invention, the grating period Λ and/or the profile shape and/or relief depth t of the first relief structure 13 is designed such that, for an angle of incidence or observation angle of from 0° to 30°, the at least one first area 21 has a reflectance of the irradiated light in at least 75% of the wavelength range of from 400 nm to 500 nm that is at least 10% lower compared with the reflectance in at least 75% of the wavelength range of from 525 nm to 700 nm.

It is preferred if the profile shape and/or relief depth t of the first relief structure 13 designed such that the at least one first area 21 has a reflectance of the irradiated light in at least 70% of the wavelength range of from 400 nm to 500 nm that is at least 15% lower compared with the reflectance in at least 70% of the wavelength range of from 525 nm to 700 nm, further preferably that the at least one first area 21 has a reflectance of the irradiated light in at least 90% of the wavelength range of from 400 nm to 500 nm that is at least 15% lower compared with the reflectance in at least 90% of the wavelength range of from 525 nm to 700 nm, and still further preferably that the at least one first area 21 has a reflectance of the irradiated light in at least 90% of the wavelength range of from 400 nm to 500 nm that is at least 20% lower compared with the reflectance in at least 90% of the wavelength range of from 525 nm to 700 nm.

In addition to the preferred designs of the profile shape and/or relief depth t and/or grating period Λ of the first relief structure, it is preferred that the at least one first area 21 has a direct reflectance of the irradiated light in at least 90% of the wavelength range of from 525 nm to 700 nm that is greater than 30%, preferably greater than 40%, preferably greater than 50%, in order that the first color impression does not appear to be too dark.

The wavelength range of from 400 nm to 500 nm corresponds in particular to the wavelength range of violet and blue light and the wavelength range of from 525 nm to 700 nm corresponds in particular to the wavelength range of green, yellow, orange and red light. The above-named design of the at least one first area 21, in particular with respect to the profile shape and/or relief depth t and/or grating period Λ, thus has the result that the proportion of blue and/or cyan-colored reflected light is smaller than the proportions of the remaining reflected light of the wavelength range visible to the human eye, preferably of from 400 nm to 700 nm. The first color impression thereby appears in a golden or coppery color shade in direct reflection for an observer.

FIGS. 5a and 5b show reflection spectra of a relief structure of a first area 21 of a functional element 2 according to the invention (continuous line), in order to illustrate the above statements. The dotted line corresponds to an example third area 23, which generates in particular a dark or black coloring, for direct comparison. In FIG. 5a the spectra with the measured original data are drawn in, whereas they are drawn in with a polynomial 5 in FIG. 5b. Degree-fitted spectra are represented. The measurements were carried out in each case in a wavelength range of from 400 nm to 700 nm (x-axis), whereas the values obtained for the reflectance between 0% and 100% are plotted on the y-axis.

It can be clearly recognized that the reflection spectrum of the first area 21 has a higher reflectance compared with the third area 23. Further, the reflectance of the first area 21 in the wavelength range of from 525 nm to 700 nm is higher than in the wavelength range of from 400 nm to 500 nm. The parameter ΔR drawn in stands for the above-mentioned preferred difference between the wavelength ranges and is illustrated for better orientation by the horizontal and vertical dashed lines.

According to a preferred embodiment example of a functional element 2, as is shown for example in FIG. 1 or FIG. 2, the profile shape of the at least one first relief structure 13 is designed asymmetrical in the x-direction and/or y-direction. In other words, the profile shape of the at least one first relief structure 13 is designed not symmetrical in the x-direction and/or y-direction. Further, it is advantageous if the profile shape varies continuously or stepwise in particular over the relief depth t.

The exciting electrical field is advantageously localized by the asymmetrical profile shape more strongly for example at the narrow tips of the relief structure 13. This can lead to a more pronounced resonance and absorption. Furthermore, the excitation of the plasmons differs on the two sides of the asymmetrical profile shapes, with the result that incident light generates a different effect depending on which of the surfaces the light is radiated onto.

Symmetrical profile shapes are for example sinusoidal or rectangular or binary. In other words, symmetrical profile shapes have a mirror symmetry when the base surface is used as a mirror plane. Here, the profile shape remains the same in the case of this mirroring, the relief structure is only shifted by half a grating period Λ.

According to the invention, asymmetrical profile shapes have no mirror symmetry in the plane spanned by the base surface.

It is preferred that Λ<300 nm, preferably Λ≤280 nm, further preferably Λ≤260 nm, applies for the values of the grating period Λ of the at least one first relief structure 13 in the x-direction and/or y-direction. Further preferably, the values of the grating period Λ of the at least one first relief structure 13 in the x-direction and/or y-direction are selected from a range of from 150 nm to 260 nm, preferably from 180 nm to 250 nm.

Further, it is advantageous that t<0.7 Λ, preferably t≤0.6 Λ, applies for the values of the relief depth t of the at least one first relief structure in the x-direction and/or y-direction. It is also advantageous that t>0.2 Λ, preferably t≥0.3 Λ, applies for the values of the relief depth t of the at least one first relief structure 13 in the x-direction and/or y-direction.

Further, it is possible for the preferably asymmetrical profile shape of the at least one first relief structure 13 to be chosen such that the width of the elevations and depressions of the at least one first relief structure 13 relative to a distance of t/2 from the base surface is at least 60% of the grating period, preferably at least 70% of the grating period and/or at most 40% of the grating period, preferably at most 30% of the grating period.

In particular, it is possible for the steepness of the sides of the at least one first relief structure 13, relative to a distance of t/2 from the base surface, to have a value in the range of from 60° to 90°, preferably of 70° and 85°.

The steepness of the sides of the at least one first relief structure 13 relative to each distance between 25% of the relief depth and 75% of the relief depth starting from the base surface is preferably chosen such that it has a value selected from a range of from 40° to 90°, preferably from 50° to 85°.

Further, it is advantageous to choose a value for the steepness of the sides of the at least one first relief structure 13, relative to each distance between 0% and 25% of the relief depth and/or between 75% and 100% of the relief depth, starting in each case from the base surface, which has a value selected from a range of from 0° to 50°, preferably from 0° to 40°.

The at least one first relief structure 13 is preferably formed as a 2D grating, preferably as a cross grating and/or as a hexagonal grating or as a more complex 2D grating. By more complex 2D gratings is meant for example 2D gratings with a preferably slight stochastic variation of the grating period. Further, by these is also meant 2D gratings with a periodic arrangement over a length of at least four times the locally present grating period and simultaneously a random arrangement over lengths of more than 100 μm. 2D gratings have a sequence of elevations and depressions in the x-direction and y-direction. This means that the one first relief structure 13 is preferably not designed as a line grating, thus as a 1D grating.

In the case of a cross grating or a hexagonal grating, the grating period Λ of the sequence of elevations and depressions with respect to both directions is preferably chosen from the above-specified ranges. Here, the grating period is preferably the same in the x-direction and y-direction. The grating period can, however, also be different in the two spatial directions.

Further, it is also possible for the periodic variation of the at least one first relief structure 13 to be superimposed at least in areas by a random and/or pseudo-random variation.

Furthermore, it is also possible to superimpose the periodic variation of the at least one first relief structure 13 at least in areas on a microstructure, in particular on a Fresnel lenses and/or a Fresnel freeform surfaces and/or on micromirrors and/or blazed gratings, in particular with a period of more than 5 μm, and/or on computer-generated hologram (CGH) structures.

Thus, it is shown by way of example in FIG. 6a that the at least one relief structure 13 comprising elevations and depressions can be superimposed on a microstructure such as a blazed grating. By way of example, a functional element 2 which represents an apple is shown here in FIG. 6b. Areas which, due to the microstructure, for example Fresnel freeform surfaces, virtually protrude from the surface or spring back behind the surface are clearly recognizable. It is hereby possible to realize, in addition to the optical effects of the at least one first relief structure 13, such as stable color impression, color tilt effect and “latent effect”, simultaneously the optical effect of the microstructure itself or to combine the optical effects of both structures.

Thus, for example, areas which, due to the microstructure, for example Fresnel freeform surfaces, an optical bulging effect virtually protruding from the surface or springing back behind the surface are not perceived achromatically, but as a gold-colored or copper-colored optical bulging effect of this type.

In the case of superimposition of a blazed grating structure, in particular with a grating period of more than 5 μm, i.e. with inclined macroscopic surfaces, by the first relief structure 13, a corresponding tilting of the first relief structure 13 by the angle of the inclined macroscopic surface with respect to a base surface occurs, whereby this relief structure 13 combined in this way generates a color impression with a larger observation angle range. In the case of superimposition of the first relief structure 13 by a Fresnel lens structure or by Fresnel freeform surfaces with varying angle of the sides, a color gradient of the combined relief structure can also be realized in the case of a superimposition by the first relief structure 13.

According to a preferred embodiment example of the invention, the functional element 2 has at least one second area 22, wherein at least one second relief structure 15 is formed in the at least one second area 22. The at least one second relief structure 15 is a relief structure which is preferably selected individually or in combination and/or superimposed from: diffractive relief structure, holographic relief structure, in particular 2D, 2D/3D or 3D hologram, matte structure, micromirror surface, reflective facet structure, refractive, almost achromatic microstructure, preferably blazed grating with a grating period of more than 5 μm, lens, microlens grid, binary random structure, binary Fresnel-shaped microstructure.

The at least one second relief structure 15 is thus designed such that, in particular under diffuse illumination, the at least one second area 22 preferably appears silver and/or in the intrinsic color of the metal which is arranged in the at least one second area and/or into which the at least one second relief structure 15 is stamped.

According to a preferred embodiment example of the invention, the functional element 2 has at least one third area 23, wherein at least one third relief structure 16 is formed in the at least one third area 23. The at least one third relief structure 16 is in particular a relief structure which comprises grating structures with a grating period Λ of more than 300 nm and a relief depth t of more than 150 nm. The at least one third area 23 preferably has a layer of high-refractive-index materials. The at least one third area 23 is designed such that it preferably has a red or dark, essentially a black, first color impression in direct reflection or in transmission.

As the optical effects such as the color impression of the different areas are substantially generated by structures, in particular the at least one first area 21, the at least second area 22 and the at least one third area 23 can be arranged register-accurately relative to each other, as the arrangement of additional varnish layers for a colored design can be dispensed with.

According to an embodiment of the invention, the at least one first area 21, the at least one second area 22, the at least third area 23 or at least one of the first, second or third areas 21, 22, 23 has a patterned shaping. One area can be molded for example in the shape of letters, numbers, a symbol, a geometric figure or a motif.

In particular, the at least one first area 21 can be designed as minitext or microtext. Further, it is possible for the first and/or second and/or third areas 21, 22, 23 to be arranged as a plurality of pixels. The pixels can be designed round, square, hexagonal, motif-shaped or also in another coherent shape. The pixels can further also have an elongated shape, in particular a line shape.

The maximum extent of a pixel in at least one direction of the spatial directions, preferably in the x-direction (Pₓ) and y-direction (P_{y}), is preferably smaller than 300 μm, preferably smaller than 100 μm, further preferably smaller than 10 μm, still further preferably smaller than 5 μm, furthermore still further preferably smaller than 3 μm. Further, it is advantageous if a pixel is formed with an extent (Pₓ, P_{y}) larger than 1 μm, preferably larger than 1.5 μm, in the x-direction and/or y-direction.

Further, as shown in FIG. 7a and FIG. 7b, it is possible for the at least one first area 21 to be designed such that it is arranged at least in two, preferably at least three, preferably at least five zones. The zones are preferably designed such that they are arranged at least 300 μm, preferably at least 1000 μm, away from each other in the x-direction and/or y-direction, with the result that they are perceived by the human eye as separated from each other. In particular, one, preferably each, of the zones has at least one first zone area which is formed smaller than 2 mm, preferably smaller than 1 mm, further preferably smaller than 0.7 mm, in at least one spatial direction b₁. Here, it can be advantageous that the at least one first zone area makes up at least 20%, preferably at least 30%, further preferably more than 50%, of the surface area of an individual zone.

It is also possible for at least one zone to have at least one second zone area which is formed larger than 2 mm, preferably larger than 3 mm, further preferably larger than 5 mm, in at least one spatial direction b₂, in particular wherein the surface area of the second zone areas of all zones is at least in total larger than 20 mm², preferably larger than 30 mm², further preferably larger than 50 mm². Further, it is also possible for the extent of at least one zone in one spatial direction to be reduced, preferably to taper continuously or stepwise.

FIG. 7b shows an example of the above embodiment in which continuously tapering zones in the shape of sunbeams of the at least one first area 21 are integrated in a design comprising at least one second area 22. The tapering zones lead up to a second area 22 designed as a temple. Further structures comprising a second area 22, which generate a radial, achromatic movement effect dependent on the tilt angle, are arranged in perfect register between the tapering zones. Further, the functional element 2 is also designed such that the background of the temple is formed of a first area 21. The design of such a combination of zones of the first area 21 and the second areas 22, thus achromatic movement effects and golden or coppery appearing subareas, can be very easily detected by the human eye.

Further, as in the design example according to FIG. 8b, the at least one first area 21 can be framed in areas or even completely enclosed by the at least one third areas 23, wherein the at least one third area 23 has an extent b₂₃ in one of the spatial directions selected from a range of from 30 μm to 1 mm, preferably from 50 μm to 300 μm, further preferably from 50 μm to 150 μm. The at least one third area 23 thus forms a contour-like frame, which frames the at least one first area 21. This is advantageous in particular, as is to be seen in FIG. 8a, in the case of minitexts or microtexts, as the legibility thereof is hereby increased. The optical effects in the first and second and third areas 21, 22, 23 preferably have as different as possible a chromaticity and thus as good as possible an optical contrast relative to each other.

In a further embodiment, which is represented in FIG. 8c, the at least one first area 21 can be framed in areas or even completely enclosed by at least one second area 22, wherein the at least one second area 22 has an extent b₂₂ in one of the spatial directions selected from a range of from 30 μm to 1 mm, preferably from 50 μm to 300 μm, further preferably from 50 μm to 150 μm. In particular, the at least one second area 22 can here be framed in areas or even completely enclosed by at least one third area 23, wherein the at least one third area 23, in particular its extent b₂₃, can be designed as in the preceding paragraph. Further, the at least one second area 22 can have a microtext or nanotext.

As the optical effects, for example the color impression, of the different areas are substantially generated by structures and not by additional printed color layers, in particular the at least one first area 21, the at least second area 22 and the at least one third area 23 can be arranged register-accurately relative to each other.

This further enables in particular the colored design of self-explanatory design elements arranged in perfect register, such as for example flags. These self-explanatory design elements can expediently be supplemented by further structure-based effects.

The functional element 2 shown in FIG. 9 is to illustrate the preceding statement. A functional element 2 is shown which also has the at least one first relief structure 13 in at least one first area 21 and the metal layer 12 arranged in at least one subarea of the first relief structure 13. Optionally, the functional element 2 has a preferably polymeric dielectric layer on the side of the metal layer 12 which faces the observer.

Further, the functional element 2 comprises two further third areas 23. The two third areas are designed in terms of their profile shape, relief depth and grating period such that they generate different first color impressions. In this example, the two third areas 23 and the one first area 21 are arranged in the shape of a flag and the areas are designed such that each of black, red or gold appear. An observer can here intuitively recognize the flag of the Federal Republic of Germany.

FIG. 10 show a further embodiment example, in which the at least one first relief structure additionally also has a color impression in transmitted light in the at least one first area 21. This is due to the increased transmission through the metal layer 12 arranged on the relief structure 13 as a result of the plasmon excitation made possible by the relief structure. The relief structure 13 according to the invention is integrated in the moon as well as in the eyes of the owl in this design. The body of the owl represented, in contrast, has a relief structure of a third area appearing dark in reflection. Other structure-based effects, for example Fresnel freeform effects or also diffractive grating structures, are preferably integrated in the rest of the design.

On the left-hand side FIG. 10 shows the design in reflected light observation and in the case of diffuse illumination. On the right-hand side in FIG. 10 the functional element 2 is shown in the case of perpendicular transmitted light observation, wherein the areas with the other structure-based effects are only to be seen as a dark border around the owl and the moon. When the functional element 2 is tilted, the color impressions in transmitted light of both relief structures change to magenta.

According to a further embodiment of the functional element 2 according to the invention, a plurality of microlenses can be arranged in the form of a grid on top of the at least one first area 21. In particular, the microlenses are arranged such that the at least one first areas 21 is perceived enlarged by an observer. In other words, the at least one first area 21 lies in the focal plane of the microlenses. For illustration, an example embodiment of a functional element 2 according to the invention according to FIG. 1 or FIG. 2 is shown in FIG. 11a, wherein another plurality of microlenses are arranged above the functional element 2, with the result that the drop-shaped item of image information shown is revealed to an observer.

In FIG. 11b it is shown how, in particular, the at least one first area 21 and for example the at least one third area 23 are here arranged in subareas such that the subareas reveal a plurality of microimages or Moiré icons arranged in the form of a grid. In particular, here, these microimages or Moiré icons are arranged in register with the plurality of microlenses arranged in the form of a grid.

Further, it is shown enlarged in FIG. 11c that the subareas are constructed in particular from a plurality of pixels, wherein the pixels are designed as already described above with respect to their spatial extent (Pₓ and P_{y}).

Depending on the desired colored design, the subareas comprise a plurality of pixels formed of the at least one first area 21, of the at least one second area 22 and/or of the at least one third area 23. For example, microimages, as shown in FIG. 11b, comprising pixels with a light white or silver coloring, dark gray or black coloring and/or a golden or coppery coloring are hereby possible.

The subareas can also be designed through the arrangement of the pixels such that a gradual transition from an increased arrangement of pixels comprising the at least one first area 21 to an increased arrangement of pixels comprising the at least one second area 22 is realized. A recognizable gradual transition from a golden or coppery appearance to a silver appearance is hereby possible.

Furthermore, it is possible through combination of the preceding embodiment variants to design the golden or coppery color impression of a subarea lighter, that is closer to the silver color shade. This can be achieved by arranging the plurality of pixels which do not comprise at least one third area 23 as a mixture, preferably a stochastic distribution, of pixels comprising the at least one first area 21 and the at least one second area 22.

Alternatively or additionally, a motif of the microimage or a motif made of Moiré icons can be constructed from pixels with a silver reflective appearance and from pixels with a dark gray to black appearance in one zone and be constructed from pixels with a golden or coppery appearance and pixels with a dark gray to black appearance in another zone of the motif. In other words, areas of the motif of the microimage or of the motif made of Moiré icons can be constructed from pixels comprising the at least one second area 22 and from pixels comprising at least one third area 23 and in another area of the motif from pixels comprising at least one first area 21 and pixels comprising at least one third area 23. Multicolored designs of the functional element 2 are hereby possible, wherein for example golden or coppery movement effects and silver movement effects are present spatially separated from each other in the security element 2.

FIG. 12 shows a further embodiment example of the functional element 2 according to FIG. 11a. The functional element 2 has the subareas already mentioned above comprising a plurality of pixels comprising first, second and/or third areas 21, 22, 23, which are formed such that they represent the number “5”. Further, a plurality of microlenses is also arranged centrally in the form of a grid, with the result that the subareas arranged there are enlarged. At least one glazing color layer 14, formed star-shaped, is now additionally arranged in particular on top of the at least one first, second and/or third area 21, 22, 23 and underneath the plurality of microlenses. With respect to the embodiments and effects of the glazing color layer, reference is made to the above statements.

FIG. 13 shows a further embodiment variant of the functional element 2 according to the invention, for example according to FIG. 1 or FIG. 2. According to this embodiment variant, a motif is formed by a plurality of pixels comprising at least the one first area 21 and by a plurality of pixels comprising at least the at least one third area 23. In other words, the functional element 2 represents a grayscale image, in particular a halftone image, or a monochromatic image. The grayscale is achieved by means of halftones through the distribution of the pixels, wherein the areas appearing dark are formed of pixels comprising third areas 23 and the areas appearing lighter are formed of pixels comprising the first area 21. With respect to the extents Pₓ or P_{y} of the pixels, reference is made to the above statements.

The functional element 2 according to the invention further provides, through its design compared with a customary grayscale image, the effect that it has a first color effect in direct reflection or zero diffraction order. In particular, the functional element 2 further provides a further surprising latent effect in the case of strong tilting, in particular in the at least first areas 21. The grayscale image can further be framed, preferably completely, by areas of the functional element 1 with further structure-based effects. For example, the grayscale image can be surrounded by a fine line movement effect, which ends at the outer contour of the grayscale image and thus directs the observer's attention to this grayscale image.

FIG. 14 shows a further embodiment of a functional element 2 according to the invention, for example according to FIG. 1. Here too, the functional element 2 has at least one first relief structure 13 in at least one first area 21. Further, a metal layer 12 is arranged in at least one subarea of the first relief structure 13 and optionally a preferably polymeric dielectric layer is arranged on the side of the metal layer 12 which faces the observer.

According to this embodiment example, the at least one first area 21 can be arranged in a first electrode layer. In particular, the first electrode layer is arranged in a reflective display or can be used in a reflective display. The first electrode layer can comprise further layers or functional elements, such as for example electrically conducting connection components and/or electromagnetic shields and/or thermal shields and/or optical shields and/or circuits.

The first electrode layer hereby has the optical effects generated by the at least one first area 21.

Further, it is advantageous if a switchable layer 30, for example an electrochromic layer or a liquid-crystal layer or a PDLC (polymer dispersed liquid crystal) layer, is arranged on top of the first electrode layer. The switchable layer 30 is characterized in that its appearance can be changed through the application of a voltage. In particular if no voltage is applied, for example in the case of the PDLC layer it appears cloudy to an observer or it appears transparent as long as a voltage is applied.

Further, a second electrode layer can be arranged on top of the first electrode layer and/or the switchable layer 30. The second electrode layer is preferably designed transparent or semitransparent and/or transparent and/or has, in particular in the wavelength range of from 400 nm to 700 nm, a transmittance of at least 50%, preferably of at least 75%, further preferably of at least 90%. Examples of such a transparent second electrode layer are a printed PEDOT:PSS layer or also a structured, preferably finely structured, metal layer appearing transparent to the human eye.

The first electrode layer is expediently arranged underneath the second electrode layer. In other words, the first electrode layer is arranged on the side of the second electrode layer facing away from an observer. In particular, the switchable layer 30 is arranged between the first and the second electrode layer.

The properties of the at least one first area 21 could hereby advantageously be integrated in a reflective display. In particular, the optical effect of the switchable layer 30 can be combined with the color effect of the lower electrode layer. Thus, in the case of a reflective display with a switchable layer 30, for example a PDLC layer, in particular in a subarea of the display which switches from cloudy to transparent due to the application of an electrical voltage (labeled “on” in FIG. 14), the golden or coppery color impression of the first electrode layer becomes visible or at least visible to an increased degree. However, if no voltage is applied to the reflective display (labeled “off” in FIG. 14), the at least one first area 21 is substantially invisible or at least only weakly visible.

A functional element 2 in a reflective display is thus obtained which is substantially only recognizable to an observer as long as a corresponding voltage is applied to the reflective display.

Further, the switchable layer 30 can also contain a dye or be dyed, whereby, in addition to the optical switching function, it also obtains a color filter function. This provides the further advantage that the appearance of the switchable layer when the voltage is applied from the color of the dye to the golden or coppery color of the lower electrode layer in the case of applied voltage.

The pigmentation level and/or the proportion by volume of the dye of the switchable layer 30 is preferably less than 15%, preferably less than 10%, further preferably less than 5%. The dye of the switchable layer 30 is preferably a soluble dye or insoluble nanoparticles.

FIGS. 15a to 15e show a further embodiment of a functional element 2 according to the invention, for example according to FIG. 1. This embodiment describes the functional element 2 preferably as a sensor element. The functional element 2 or sensor element can be used for example in a sensor as product. The mode of operation of the functional element 2 is for example to detect a specific substance.

FIGS. 15a to 15d show schematic sectional representations of different possible embodiments of a functional element 2 according to the invention and FIG. 15e shows a schematic top view onto the functional element before (on the left) and during and/or after (on the right) contact with the substance to be detected.

Here too, the functional element 2 has at least one first relief structure 13 in at least one first area 21. The at least one first relief structure 13 is not represented in FIGS. 15a to 15d for the sake of simplicity. Further, a metal layer 12 is arranged in at least one subarea of the first relief structure 13, and optionally in at least one subarea of the metal layer 12 a preferably polymeric sensor layer 17 is arranged on the side of the metal layer 12 which faces the observer. In particular, the region of the above subarea which is brought into contact with the medium having the substance to be detected forms the sensor area. The sensor layer 17 here changes its refractive index and/or absorption coefficient if it comes into contact with a sufficient quantity of the substance to be detected. This leads to an alteration of the color impression perceptible to the human eye. Because of the increased absorption of the dye on the surface of the at least one metal layer 12 with the first relief structure 13, this alteration of the color impression is already recognizable in the case of relatively low concentrations of the substance to be detected. The enhancement mechanism is called plasmon-enhanced absorption. The alteration of the color impression perceptible to the human eye is here much greater compared with a metal layer 12 with the sensor layer 17, which does not have at least one first relief structure 13. This variable absorption behavior can be reversible or also irreversible.

Optionally, another preferably dielectric contrast layer 18 can be provided, which covers subareas of the sensor which faces the observer, and in which the at least one first relief structure 13, the metal layer 12 and the sensor layer 17 are all arranged. The function of this contrast layer 18 is to protect the covered subareas of the sensor layer 17 from the contact with the substance to be detected, in order that these areas do not exhibit the change in the color impression triggered by the substance to be detected. The contrast between these different areas is thus particularly easily perceptible for the human eye.

FIG. 15a shows the sensor element 2 before and FIG. 15b shows it during and/or after contact with the substance to be detected. The contrast layer 18 preferably has a refractive index which is close to the refractive index of the medium which contains the substance to be detected. The refractive index of the contrast layer 18 preferably differs from the refractive index of the medium which contains the substance to be detected by up to ±10%, further preferably by up to ±5%, and still further preferably by up to ±2%. If for example the substance to be detected is to be detected dissolved in water (refractive index n_{H2O}≈1.33), then Teflon (refractive index n_{Teflon}≈1.31), PVDF polyvinylidene fluoride (refractive index n_{PVDF}≈1.42) or also magnesium fluoride MgF₂ (refractive index n_{MgF2}≈1.38) are possible materials for the contrast layer 18.

FIG. 15e shows the sensor function in a schematic top view, wherein here the contrast layer 18 is designed such that areas of the sensor layer 17 in the shape of a lightning bolt are not covered. The functional element 2 represented on the left-hand side of FIG. 15e shows the state before the functional element 2 comes into contact with the substance to be detected. The lightning bolt is not, or almost not, recognizable. The functional element 2 represented on the right-hand side of FIG. 15e shows the state while the functional element 2 is in contact with the substance to be detected. The lightning bolt is clearly recognizable because of the alteration of the color impression.

For example, the sensor layer 17 can consist of a dye, embedded in a polymer matrix. Methyl orange, bromothymol blue or phenolphthalein are suitable as dyes for example for pH sensors. They show different colors in aqueous solution depending on the pH. Phenolphthalein for example is transparent for pH values smaller than 8 and becomes magenta-colored from pH values of 9. In the case of a very high pH value close to 14 it becomes colorless again. In the case of a quite low pH value smaller than zero the indicator changes color to red orange.

Different substances, whether gaseous or liquid, can be detected depending on the sensor layer 17 or dye in the sensor layer 17. Gaseous NO₂ for example reacts with perylene and changes the complex refractive index of this material, which leads to a change in the color impression of the functional element 2 in the case of sufficient concentration of the gas. Perylene can be applied directly to the metal layer 12 for example by means of a PECVD process.

FIG. 15c shows a design of the functional element 2 for a sensor in which a filtering transparent, in particular an open-pored, layer 19 is additionally applied at least to the sensor area. In other words, a filtering transparent, in particular an open-pored, layer 19 is arranged on top of the side of the sensor layer 17 which faces the observer. This filtering layer 19 is permeable for the substance to be detected present in the medium and prevents other substances present in the medium from reaching the sensor layer 17. This makes it possible to reduce or prevent undesired reactions of the sensor layer 17 with other substances likewise present in the medium. Optionally, another, preferably polymeric, sealing layer 20, which prevents the medium from escaping at the edges of the functional element 2, is provided in the edge area of the functional element 2.

FIG. 15d shows a further design, in which the medium is conveyed to the sensor area through a vertically running channel 24. The channel 24 can be formed as a microfluidic system. The channel 24 can optionally be sealed with a further preferably polymeric sealing layer 20. The sealing layer 20 is preferably formed transparent.

The production of a functional element 2, in particular a sensor element, can be realized as follows. The at least one first relief structure 13 can be created by means of known methods such as holographic two-beam exposure or by means of e-beam lithography on a glass substrate. A nickel shim with the at least one first relief structure 13 can be obtained herefrom according to known state of the art by means of a galvanic copying process. The nickel shim can be duplicated according to known methods and then the at least one first relief structure 13 can be produced in roll-to-roll methods, for example thermal replication or UV replication, in a flexible film.

Among other things, it can be advantageous for a functional element 2, preferably for a sensor element, if the at least one first relief structure 13 is realized on a rigid substrate, for example a glass substrate or a quartz substrate. This makes it easier to handle for example liquid media. For this, the at least one first relief structure 13 can be copied from the nickel shim in a UV copying process directly onto the rigid substrate, for example glass substrate or quartz substrate. Known processes for this use so-called sol-gel materials, such as for example ormocer, which are applied to the rigid substrate in liquid form. The nickel shim is then placed on the rigid substrate, for example the glass substrate or the quartz substrate, with the result that a thin film of the sol-gel material remains between the rigid substrate and the nickel shim. This is followed by the curing of the sol-gel material by means of UV radiation through the rigid substrate, for example glass substrate or quartz substrate, as well as the detachment of the nickel shim. The metal layer 12 can then be vapor-deposited or sputtered in vacuum onto the surface of the cured sol-gel layer with the at least one first relief structure 13. The sensor layer 17 can then be applied to the metal layer 12, for example by means of spin coating, as a thin layer.

A further schematic embodiment of a functional element 2 is shown in FIGS. 16 and 17. This embodiment describes a transfer film as functional element 2. The functional element 2 according to FIGS. 16 and 17 can have the designs as described in FIG. 1. FIG. 17 shows the schematic sectional representation of the transfer film.

FIG. 16 shows the schematic top view onto the transfer film, wherein the carrier layer 501 has already been peeled off the transfer layer, with the result that the at least one first relief structure 13 forms the side facing the observer over the whole surface.

The transfer film has a carrier layer 501 and a transfer layer detachable from the carrier layer 501. The carrier layer 501 can have a separating layer 502. One or more further layers of the following layers are arranged on the carrier layer 501, preferably in the following order, wherein they preferably form the transfer layer: a detachment layer 503, a replication layer 504 comprising the at least one first relief structure 13, a metal layer 12, a primer layer 506 and an adhesive layer 507.

The carrier layer 501 preferably consists of polyester, further preferably of PET, and the separating layer 502 preferably consists of wax. The metal layer 12 is preferably formed of aluminum and was preferably vapor-deposited. Further, the at least one first relief structure 13 of the functional element 2 is preferably arranged over the whole surface in the replication layer 504. The at least one first area 21 is arranged in the transfer layer, in particular over the whole surface, perpendicular to the plane spanned by the replication layer 504 in the observation direction.

Typical methods for transferring the transfer layer are for example the hot-stamping method and the cold-stamping method.

FIG. 18 shows an embodiment of a product 1 comprising a functional element 2. This embodiment describes for example a bottle label of a wine bottle. The bottle label comprises a paper label for sticking onto a bottle. The label contains, as decorative ply, a decorative frame hot-stamped onto the paper label made of the transfer film described in FIGS. 16 and 17. The transfer of the transfer layer is effected by means of hot-stamping methods or cold-stamping methods. The carrier layer 501 can be peeled off after the transfer of the transfer layer. The bottle label shown in FIG. 18 additionally has further decorative elements, which have been stamped onto the bottle label. The word “wine” is stamped onto the paper label for example using a gold foil customary in the trade and the year “2021” is stamped for example using a “silver foil” customary in the trade.

By a silver foil is preferably meant an aluminized foil without diffractive or refractive structures. Such foils are also called mirror foils. Further, by gold foil is preferably meant an aluminized foil without diffractive or refractive structures which has an additional, preferably yellow-glazed, layer arranged on the aluminum layer in the observation direction.

Furthermore, by way of example, the word “IDLA” has been stamped using aluminized transfer film with diffractive matte structures. Such foils are similar to the foils described in FIGS. 16 and 17, wherein matte structures already described above are used instead of the relief structure according to the invention.

Prints, which can be arranged next to, under or over the stamped areas, can additionally be applied to the label.

The decorative frame represented in FIG. 18 comprising the functional element according to the invention can fulfil two functions. On the one hand, it represents a decorative element which has an interesting color change dependent on the angle of view. On the other hand, it serves at the same time as a security element for protection against forgeries.

FIG. 19 shows the layer structure of a functional element according to the invention as a label film and/or laminating film. The label film and/or laminating film has one or more of the following layers, preferably in the following order: a carrier layer 501, a primer layer 506, a replication layer 504 comprising the at least one first relief structure 13, a metal layer 12 and an adhesive layer 507.

The carrier layer 501 preferably consists of polyester, further preferably of PET, and the adhesive layer 507 is preferably a cold adhesive layer. The metal layer 12 preferably consists of aluminum and was preferably vapor-deposited. Further, the at least one first relief structure 13 is preferably arranged over the whole surface in the replication layer 504.

A further example embodiment of a product comprising a functional element 2 is shown in FIG. 20. This embodiment shows for example a label based on the label film and/or laminating film described in FIG. 19 on packaging for example for pharmaceutical products. The label shown in FIG. 20 is attached in the upper area of the packaging in areas over the hinged lid and the lower area of the packaging. For example the lettering “SECURE” is further printed on the label film and/or laminating film, and a lettering “ETRO—PF—” is additionally stamped onto the packaging using a silver foil customary in the trade.

The label arranged on the packaging in FIG. 20 can fulfil the essential aspects of a security element and a decorative element. Thus, it has a color change dependent on the angle of view and directs the observer's attention to itself. The latter can then easily recognize whether the packaging has already been opened. Further, the label also provides protection from forgeries.

Of course, the above-listed embodiment variants of the functional elements 2 or products 1 can be combined with each other as desired and do not represent a limitation, in particular in terms of the shaping and combination thereof.

### LIST OF REFERENCE NUMBERS

1 product
2 functional element
10 carrier substrate
11 window area
12 metal layer
13 first relief structure
14 glazing varnish layer
15 second relief structure
16 third relief structure
17 sensor layer
18 contrast layer
19 filtering layer
20 sealing layer
21, 211, 212 first area
22 second area
23 third area
24 channel
30 switchable layer
100 light source
200 angle of incidence
300 angle of emergence
400 normal of the base surface
501 carrier layer
502 separating layer
503 detachment layer
504 replication layer
506 primer layer
507 adhesive layer

1. A functional element comprising at least one first relief structure in at least one first area and at least one metal layer arranged in at least one subarea of the at least one first relief structure,
wherein the at least one first relief structure has a periodic variation of elevations and depressions in the x- and y-direction,
wherein the elevations succeed each other with a grating period Λ which is smaller than a wavelength of the light visible to the human eye,
wherein the minima of the depressions define a base surface and wherein the at least one first relief structure has a relief depth t,
wherein in the at least one first area a first color impression forms in the case of a first angle of incidence and a second color impression forms in the case of a second angle of incidence,
wherein the first angle of incidence is selected from a range of from 0° to 30°,
wherein an optical effect different from the first and second color impression forms in the case of a third angle of incidence in the at least one first area,
and wherein the third angle of incidence has a value of 60° or more.

2. (canceled)

3. The functional element according to claim 1, wherein
the second color impression is generated depending on the azimuthal angle.

4-6. (canceled)

7. The functional element according to claim 1, wherein
the periodic variation of the at least one first relief structure is superimposed at least in areas by a random and/or pseudo-random variation.

8. The functional element according to claim 1, wherein
the periodic variation of the at least one first relief structure is superimposed at least in areas on a microstructure.

9. The functional element according to claim 1, wherein
the at least one first relief structure is formed as a cross grating and/or as a hexagonal grating or as a more complex 2D grating.

10. The functional element according to claim 1, wherein
Λ<300 nm, applies for the values of the grating period Λ of the at least one first relief structure in the x-direction and/or y-direction.

11. The functional element according to claim 1, wherein
the values of the grating period Λ of the at least one first relief structure in the x-direction and/or y-direction are selected from a range of from 150 nm to 260 nm.

12. The functional element according to claim 1, wherein
t<0.7 Λ, applies for the values of the relief depth t of the at least one first relief structure in the x-direction and/or y-direction.

13. The functional element according to claim 1, wherein
t>0.2 Λ, applies for the values of the relief depth t of the at least one first relief structure in the x-direction and/or y-direction.

14. The functional element according to claim 1, wherein
the profile shape of the at least one first relief structure is varied continuously or stepwise.

15. The functional element according to claim 1, wherein
the profile shape of the at least one first relief structure is designed asymmetrical in the x-direction and/or y-direction.

16. The functional element according to claim 1, wherein
the width of the elevations and depressions of the at least one first relief structure relative to a distance of t/2 from the base surface is at least 60% of the grating period, and/or at most 40% of the grating period.

17. The functional element according to claim 1, wherein
a polymer layer, is arranged on top of and/or underneath the at least one first relief structure.

18. The functional element according to claim 1, wherein
the at least one first area has a reflectance of the irradiated light in at least 75% of the wavelength range of from 400 nm to 500 nm that is at least 10% lower compared with the reflectance in at least 75% of the wavelength range of from 525 nm to 700 nm.

19. The functional element according to claim 1, wherein
the at least one first area has a reflectance of the irradiated light in at least 90% of the wavelength range of from 525 nm to 700 nm that is greater than 30%.

20. The functional element according to claim 1, wherein
a dye and/or a luminescent substance is arranged in the at least one first area.

21. The functional element according to claim 1, wherein
a dye and/or a luminescent substance are arranged in a dielectric layer.

22. The functional element according to claim 1, wherein
the functional element has at least one second area, wherein at least one second relief structure is formed in the at least one second area.

23. (canceled)

24. The functional element according to claim 22, wherein
the functional element has at least one third area, wherein at least one third relief structure is formed in the at least one third area.

25. (canceled)

26. The functional element according to claim 1, wherein
the at least one first area is designed such that it is arranged at least in two.

27-32. (canceled)

33. The functional element according to claim 1, wherein
the first area is arranged as a plurality of pixels, wherein the pixels are designed round, square, hexagonal, motif-shaped or also in another coherent shape and/or have an elongated shape.

34. (canceled)

35. The functional element according to claim 33, wherein
a plurality of microlenses are arranged in the form of a grid on top of the at least one first area.

36. The functional element according to claim 35, wherein
the grid of the microlenses has several microlens partial grids.

37. The functional element according to claim 1, wherein
the at least one first area is arranged in a first electrode layer.

38. The functional element according to claim 37, wherein a switchable layer is arranged on top of the first electrode layer, wherein
the switchable layer contains a dye and/or is dyed.

39-41. (canceled)

42. The functional element according to claim 1, wherein
a sensor layer is arranged on at least one subarea of the metal layer on the side of the metal layer which faces the observer, wherein a dye and/or a luminescent substance is arranged in the sensor layer.

43. The functional element according to claim 42, wherein
a contrast layer is arranged in areas, seen from an observer, on top of the sensor layer.

44. The functional element according to claim 42, wherein
the functional element further has a filtering transparent, layer which is arranged on top of the sensor layer, seen from an observer.

45. (canceled)

46. The functional element according to claim 1, wherein
at least one glazing color layer is arranged, at least in areas or over the whole surface in the viewing direction of an observer, underneath the at least one first area.

47. The functional element according to claim 46, wherein
the at least one glazing color layer directly adjoins the metal layer or is spaced apart from the metal layer by a dielectric intermediate layer.

48. The functional element according to claim 46, wherein
the at least one glazing color layer, has a total ink holdout dE of from 50 to 270, from the at least one first.

49. The functional element according to claim 46, wherein
the at least one glazing color layer, has a darker color, and the at least one first has a lighter color.

50. The functional element according to claim 46, wherein,
the at least one glazing color layer, has a lighter color, and the at least one first has a darker color.

51. The functional element according to claim 24, wherein
the at least one first area and/or the at least one second area have a total ink holdout dE of from 50 to 270, from the at least one third area.

52. The functional element according to claim 24, wherein
the at least one first area and/or the at least one second area has a lighter color compared with the at least one third area.

53. The functional element according to claim 1, wherein
the at least one first area is arranged in subareas such that the subareas reveal a plurality of microimages or Moiré icons arranged in the form of a grid.

54. The functional element according to claim 53, wherein
the grid of the microimages or Moiré icons has several partial grids, wherein within a partial grid the microimages or Moiré icons are arranged in a one-dimensional arrangement of the microimages or Moiré icons or are arranged in a two-dimensional arrangement of the microimages or Moiré icons.

55. The functional element according to claim 53, wherein
the microimages or Moiré icons within a partial grid are formed such that for each partial grid an optical effect allocated to the partial grid forms.

56. The functional element according to claim 53
for different optical effects for each partial grid, the microimages or Moiré icons have differently formed and/or a different number of at least one first areas and/or at least one glazing color layers in front of and/or behind the at least one first areas.

57. (canceled)

58. A method for producing a functional element according to claim 1, wherein at least one first relief structure is arranged in at least one first area of the functional element and a metal layer is arranged at least in at least one subarea of the at least one first relief structure,
with the result that the at least one first relief structure has a periodic variation of elevations and depressions in the x- and y-direction,
and the elevations succeed each other with a grating period Λ which is smaller than a wavelength of the light visible to the human eye,
and with the result that the minima of the depressions define a base surface and the at least one first relief structure has a relief depth t,
wherein in the at least one first area a first color impression forms in the case of a first angle of incidence and a second color impression forms in the case of a second angle of incidence,
wherein the first angle of incidence is selected from a range of from 0° to 30°,
wherein an optical effect different from the first and second color impression forms in the case of a third angle of incidence in the at least one first area,
and wherein the third angle of incidence has a value of 60° or more.

59. The method according to claim 58, wherein
the at least one metal layer is vapor-deposited and/or sputtered in vacuum in at least one subarea of the at least one first area.

60. The method according to claim 58, wherein
a polymer layer is arranged on top of the side of the at least one first relief structure facing an observer.

61. A method according to claim 58, wherein
a dye and/or a luminescent substance is arranged in the at least one first area.

62. A method according to claim 58, wherein
a dielectric layer is printed or vapor-deposited on top of and/or underneath the at least one metal layer.

63. The method according to claim 58, wherein
at least one glazing color layer is arranged at least in areas or over the whole surface, underneath the at least one first area.

64. A product comprising a functional element according to claim 1.
